(19) United States
(12) Patent Application Publication
(10) Pub. No.: US 2004/0064582 A1
(43) Pub. Date: Apr. 1, 2004

(54) Apparatus and method for enabling intserv quality of service using diffserv building blocks

(76) Inventors: Arun Raghunath, Beaverton, OR (US); Shriharsha Hegde, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/262,026

(22) Filed: Sep. 30, 2002

(51) Int. Cl. G06F 15/173

(52) U.S. Cl. 709/240

(57) ABSTRACT

A method and apparatus for enabling INTSERV guaranteed/controlled-load service using DIFFSERV building blocks are described. In one embodiment, the method includes the identification of packets from an incoming traffic stream that belong to one of a plurality of flows receiving a contracted quality of service (QoS). Once identified, it is determined whether each respective, identified packet conforms to a predetermined traffic specification for a respective flow to which the respective identified packet belongs. Next, each conforming packet is assigned to a queue from one or more available queues. Finally, packets are selected from each of the one or more queues for transmission in order to maintain performance of each selected packet to the predetermined traffic specification for the respective flow to which the respective packet belongs.

### FIELD OF THE INVENTION

One or more embodiments of the invention relate generally to the field of network communications. More particularly, one or more of the embodiments of the invention relates to a method and apparatus for enabling varying quality of service using differentiated services (DIFFSERV) building blocks.

### BACKGROUND OF THE INVENTION

A variety of applications, including teleconferencing, remote seminars, telescience and distributed simulation have emerged that require real-time service. The emergence of such multimedia and real-time applications, which utilize the Internet, has fed the demand for varying quality of service (QoS) from available networks. Unfortunately, the traditional best effort service model utilized by the Internet does not suit such real-time or multimedia applications.

As known to those skilled in the art, the best effort service model does not pre-allocate bandwidth for handling network traffic. Consequently, variable queuing delays and congestion across the Internet are common. In addition, network operators desire the ability to control the sharing of bandwidth on a particular link among different traffic classes with the facility to assign to each class a minimum percentage of the link bandwidth under conditions of overload, while allowing unused bandwidth to be available at other times to handle such multimedia and real-time applications.

Currently, there are two different models for providing service differentiation for traffic flows, which include the integrated services (INTSERV) model and the differentiated services (DIFFSERV) model. The integrated services model attempts to enhance the Internet service model to ably support audio, video and real-time traffic, in addition to normal data traffic. This model aims to provide some control over end-to-end packet delays and allows a management facility, commonly referred to as controlled link sharing. In addition, the INTSERV model provides a reference framework and a broad classification of the sorts of services that might be desired from the network elements.

The integrated services model provides details on a few specific services. However, since end-to-end flow set-up requires cooperation amongst all intermediate network elements, the INTSERV specification clearly defines characterization parameters and how they are to be composed for interoperability. In contrast, the DIFFSERV model provides qualitative differentiation to flow aggregates unlike the hard guarantees, such as delay bounds and assured bandwidth provided by the INTSERV model. For example, the qualitative differentiation provided by the DIFFSERV model may be configured to provide Class A a higher priority than Class B. In other words, DIFFSERV provides no strict guarantees in terms of delay or bandwidth or the like to flows.

Furthermore, the two models are fundamentally different in the way they operate and the level of service they provide. Specifically, INTSERV requires a flow state to be maintained along the entire end-to-end datapath, while DIFFSERV does not maintain such a flow state. In contrast, the DIFFSERV model requires an isolated decision at each router on the level of service provided, based on values of fields within received packets. As a result, network elements are generally required to provide separate data planes for modules handling both INTSERV traffic and DIFFSERV traffic. Therefore, there remains a need to overcome one or more of the limitations in the above-described, existing art.

### BRIEF DESCRIPTION OF THE DRAWINGS

The various embodiments of the present invention are illustrated by way of example, and not by way of limitation, in the figures of the accompanying drawings and in which:

FIG. 1 depicts a block diagram illustrating a conventional computer network, as known in the art.

FIG. 2 depicts a block diagram illustrating the conventional network, as depicted in FIG. 1, further illustrating various network elements utilized to route packages within the network, as known in the art.

FIG. 3 depicts a block diagram illustrating a conventional network element, utilized within the conventional network depicted in FIG. 2.

FIG. 4 depicts a block diagram illustrating a network element utilized to provide integrated services (INTSERV) controlled load service, utilizing differentiated service (DIFFSERV) building blocks, in accordance with one embodiment of the present invention.

FIG. 5A depicts a block diagram illustrating INTSERV parameters, in accordance with one embodiment of the present invention.

FIG. 5B depicts a block diagram illustrating DIFFSERV parameters, utilized to provide controlled load services within the network element, as depicted in FIG. 4, in accordance with the further embodiment of the present invention.

FIG. 6 depicts a block diagram illustrating a network element, utilized to provide INTSERV guaranteed service, utilizing DIFFSERV building blocks, in accordance with the further embodiment of the present invention.

FIG. 7A depicts INTSERV parameters, utilized by the network element, as depicted in FIG. 6, in order to provide INTSERV guaranteed service, in accordance with a further embodiment of the present invention.

FIG. 7B depicts a block diagram illustrating DIFFSERV parameters utilized to provide INTSERV guaranteed service within a network element, as depicted in FIG. 6, in accordance with a further embodiment of the present invention.

FIG. 8 depicts a block diagram illustrating a network element configured to provide varying quality of service (QoS), in accordance with a further embodiment of the present invention.

FIG. 9 depicts a flowchart illustrating a method for providing INTSERV controlled load service, utilizing network elements containing DIFFSERV building blocks, in accordance with one embodiment of the present invention.

FIG. 10 depicts a flowchart illustrating an additional method for identifying flows that have contracted to receive a specific quality of service (QoS), in accordance with a further embodiment of the present invention.

FIG. 11 depicts a flowchart illustrating an additional method for generating a meter for each respective flow receiving a contracted quality of service, in accordance with the further embodiment of the present invention.

FIG. 12 depicts a flowchart illustrating an additional method for generating one or more queues, wherein each queue is assigned a burst level range and receives packets having a corresponding burst level thereto, in accordance with the further embodiment of the present invention.

FIG. 13 depicts a flowchart illustrating an additional method for calculating a threshold rate for servicing of a packets from the various queues, in accordance with the further embodiment of the present invention.

FIG. 14 depicts a flowchart illustrating an additional method for identifying packets from an incoming traffic stream belonging to one of a plurality of flows receiving a contracted quality of service (QoS), in accordance with the further embodiment of the present invention.

FIG. 15 depicts a flowchart illustrating an additional method for determining identified packets, which conform to a predetermined traffic specification for a respective flow, to which the respective packet belongs, in accordance with the further embodiment of the present invention.

FIG. 16 depicts a flowchart illustrating an additional method for assigning conforming packets to one or more available queues, in accordance with a further embodiment of the present invention.

FIG. 17 depicts a flowchart illustrating an additional method for servicing packets from the one or more available queues, in order to maintain conformance of each selected packets to a predetermined traffic specification, in accordance with an exemplary embodiment of the present invention.

FIG. 18 depicts a flowchart illustrating a method for providing INTSERV guaranteed service utilizing network elements containing DIFFSERV building blocks, in accordance with one embodiment of the present invention.

FIG. 19 depicts a flowchart illustrating an additional method for modifying traffic specifications of various flows, in accordance with a path delay between a current network element and a source of the respective flow, in accordance with a further embodiment of the present invention.

FIG. 20 depicts a flowchart illustrating an additional method for determining whether to increase a number of available queues during QoS set-up, in accordance with a further embodiment of the present invention.

FIG. 21 depicts a flowchart illustrating an additional method for determining a reservation rate, in accordance with an aggregate network path delay, in accordance with a further embodiment of the present invention.

FIG. 22 depicts a flowchart illustrating an additional method for identifying packets belonging to one of the plurality of flows receiving a contracted QoS, in accordance with a further embodiment of the present invention.

FIG. 23 depicts a flowchart illustrating an additional method for determining whether identified packets conform to a predetermined traffic specification for a respective flow to which the respective packet belongs, in accordance with the further embodiment of the present invention.

FIG. 24 depicts a flowchart illustrating an additional method for identifying selected packets that conform to a traffic specification modified in view of a calculated network path delay, in accordance with a further embodiment of the present invention.

FIG. 25 depicts a flowchart illustrating an additional method for processing non-conforming packets, in accordance with a further embodiment of the present invention.

FIG. 26 depicts a flowchart illustrating an additional method for buffering non-conforming packets in order to conform the packets to a traffic specification thereof, in accordance with a further embodiment of the present invention.

### DETAILED DESCRIPTION

A method and apparatus for enabling integrated services (INTSERV) guaranteed/controlled-load service using differentiated services (DIFFSERV) building blocks are described. In one embodiment, the method includes the identification of packets from an incoming traffic stream that belong to one of a plurality of flows receiving a contracted quality of service (QoS). Once identified, it is determined whether each respective, identified packet conforms to a predetermined traffic specification for a respective flow to which the respective identified packet belongs. Next, each conforming packet is assigned to a queue from one or more available queues. Finally, packets are selected from each of the one or more queues for transmission in order to maintain performance of each selected packet to the predetermined traffic specification for the respective flow to which the respective packet belongs.

In the following description, for the purposes of explanation, numerous specific details are set forth in order to provide a thorough understanding of the embodiments of the present invention. It will be apparent, however, to one skilled in the art that the various embodiments of the present invention may be practiced without some of these specific details. In addition, the following description provides examples, and the accompanying drawings show various examples for the purposes of illustration. However, these examples should not be construed in a limiting sense as they are merely intended to provide examples of the embodiments of the present invention rather than to provide an exhaustive list of all possible implementations of the embodiments of the present invention. In other instances, well-known structures and devices are shown in block diagram form in order to avoid obscuring the details of the various embodiments of the present invention.

In an embodiment, the methods of the various embodiments of the present invention are embodied in machine-executable instructions. The instructions can be used to cause a general-purpose or special-purpose processor that is programmed with the instructions to perform the methods of the embodiments of the present invention. Alternatively, the methods of the embodiments of the present invention might be performed by specific hardware components that contain hardwired logic for performing the methods, or by any combination of programmed computer components and custom hardware components.

In one embodiment, the present invention may be provided as a computer program product which may include a machine or computer-readable medium having stored thereon instructions which may be used to program a computer (or other electronic devices) to perform a process according to one embodiment of the present invention. The computer-readable medium may include, but is not limited to, floppy diskettes, optical disks, Compact Disc, Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or the like.

System Architecture

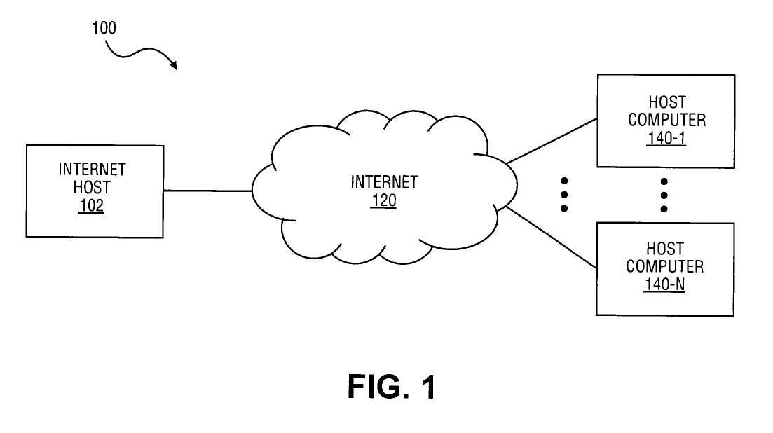

Referring now to FIG. 1, FIG. 1 depicts a conventional network 100, including an Internet host 102 coupled to host computers 140 (140-1, . . . , 140-N) via the Internet 120. Generally, the routing of information between Internet host 102 and host computers 140 is performed utilizing packet switching of various information transmitted via packetized data, which is routed within the Internet from the Internet host 102 to the various host computers. While this model is successful when transmitting conventional packetized information, a variety of applications, including teleconferencing, as well as multimedia applications, have emerged, which require real-time service. As a result, the emergence of such multimedia and real-time applications, which utilize networks, such as depicted in FIG. 1, have driven the demand for varying quality of service (QoS) from available networks.

Unfortunately, networks, as depicted in FIG. 1, utilize a traditional best effort service model, which does not pre-allocate bandwidth for handling network traffic, but simply routes packets utilizing current available bandwidth on a best effort basis. As a result, varying queueing delays and congestion across the Internet are quite common. Therefore, in order to support multimedia, as well as real-time applications, within the network 100, as depicted in FIG. 1, the traditional best effort service model requires enhancement in order to provide varying quality of service to traffic flows which utilize the network.

Currently, there are two different models for providing service differentiation (varying QoS) for traffic flows, which include the integrated services (INTSERV) model and the differentiated services (DIFFSERV) model. The integrated services model attempts to enhance the Internet service model to ably support audio, video and real-time traffic, in addition to normal data traffic. This model aims to provide some control over end-to-end packet delays and allows a management facility, commonly referred to as controlled link sharing. In addition, the INTSERV model provides a reference framework and a broad classification of the sorts of services that might be desired from the network elements.

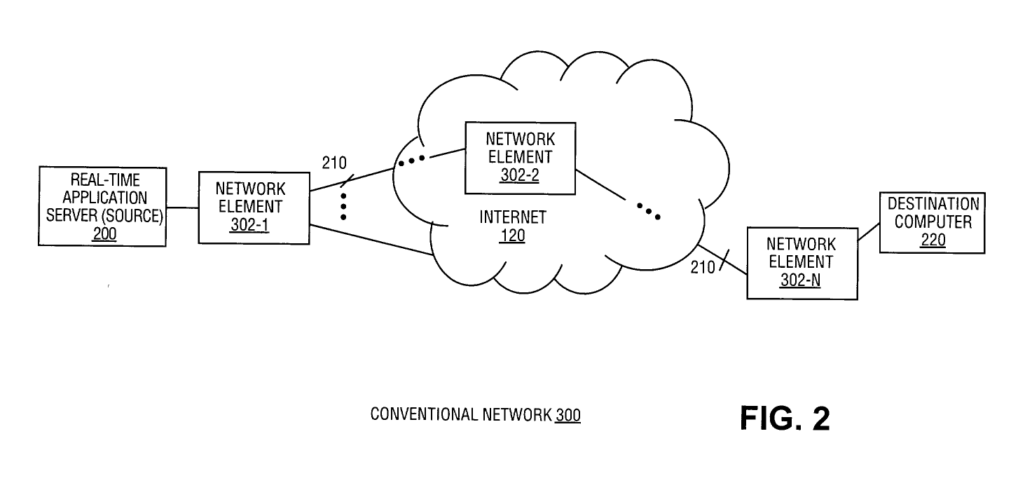

For example, referring to FIG. 2, FIG. 2 depicts a block diagram further illustrating the network of FIG. 1, depicted to illustrate the various network elements between a real-time application server (source) computer 200 and a destination computer 220. As such, the implementation of the integrated services model within the network 300, as depicted in FIG. 2, requires cooperation amongst all intermediate network elements 302 (302-1, . . . , 302-N). The INTSERV model is designed to provide hard guarantees, such as, delay bounds and assured bandwidth to individual end-to-end flows, which are provided utilizing services, such as, controlled load service, provided by the intermediate network elements, as well as guaranteed service, provided by the intermediate network elements, as described in further detail below.

In contrast, the DIFFSERV model provides qualitative differentiation to flow aggregates, unlike the hard guarantees, such as, delay bounds and assured bandwidth provided by the INTSERV model. For example, the qualitative differentiation provided by the DIFFSERV model may be configured to provide Class A a higher priority than Class B. Furthermore, the two models are fundamentally different in the way they operate and the level of service they provide. As such, separate modules within a network element are typically implemented to support both models.

INTSERV Flow Specifications

The INTSERV model attempts to set-up QoS along the entire path between communicating end points, for example, within the network 300, as depicted in FIG. 2. As a result, cooperation is required among all intermediate network elements 302 in order to provide the desired QoS. Accordingly, INTSERV requires a standardized framework in order to provide multiple qualities of service to applications. In addition, INTSERV specifies functionality requires that internetwork system components are required to provide to support the varying QoS.

Accordingly, when a series of network elements providing a particular service are concatenated along the end-to-end datapath, they provide applications with a more predictable network service. Furthermore, the service definitions specified by the INTSERV model describe the parameters required to invoke the service, the relationship between the parameters and the service delivered and the final end-to-end behavior to expect by concatenating several instances of the service. Accordingly, the INTSERV model includes two quantitative QoS mechanisms: (1) controlled load service; and (2) guaranteed service.

Controlled Load Service

Controlled load service (CLS) provides a client data flow with a quality of service closely approximating the QoS that same flow would receive from a network element that is not highly loaded. As such, the end-to-end behavior provided to an application by a series of network elements providing CLS tightly approximates the behavior visible to applications receiving best effort service under lightly loaded conditions from the same series of network elements. In order to ensure that controlled load service is provided when the network is overloaded, an estimate of the traffic generated by the flow is provided to network elements.

Accordingly, using the estimate, the network elements may set aside the required resources to handle the application's traffic. To this end, a CLS flow is described to the various network elements using a token bucket traffic specification (TSpec). Accordingly, traffic that conforms to the TSpec is forwarded by the network elements with a minimal packet loss and queueing delay not greater than that caused by the traffic's own burstiness. Likewise, the non-conforming traffic is not thrown away, but is handled in such a way that it does not affect other traffic, including best effort traffic. This allows an application to request some minimum amount of QoS and then exceed the QoS amount by transmitting data packets at a rate in excess of the requested amount. As such, when there is no other traffic, the application will get better service. However, if there is other traffic, the application receives at least up to the requested amount of service.

Guaranteed Service

Guaranteed service (GS) provides client data flows an assured level of bandwidth and a delay bounded service. The end-to-end behavior provided to an application by a series of network elements providing guaranteed service conforms to the fluid model of service. As known to those skilled in the art, the fluid model of service, at a service rate R, is essentially the service that is provided to a flow by a dedicated wire of bandwidth R between the source and receiver. As such, the flow service is independent of any other flow. Hence, for a flow obeying a token bucket (r,b), provides a delay bounded by b/R, where R represents the service rate, while b represents the bucket size of the GS traffic.

Accordingly, GS with a service rate R, where R is the share of the bandwidth other than the bandwidth of a dedicated line, approximates this behavior. Consequently, since GS is an approximation, there are not any dedicated lines for the flows. Instead, there are a number of network elements, each of which set aside a portion of their bandwidth for a flow. Consequently, by setting aside the required bandwidth, GS provides strict mathematical assurance of both throughput and queueing delay. As such, GS service is intended for applications, such as, audio/video playback streams that require a firm guarantee that a datagram will arrive no later than a certain time after it is transmitted by its source.

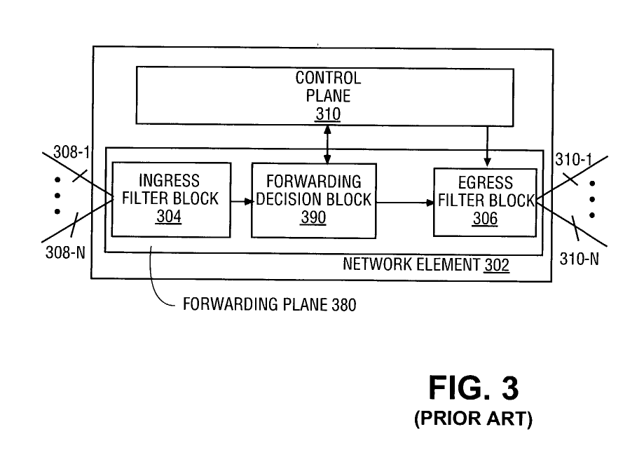

Referring now to FIG. 3, FIG. 3 depicts a conventional network element 302, as utilized within network 300, as depicted in FIG. 2. As illustrated, the network element includes a forwarding plane 380, which utilizes an ingress filter block 304, a forwarding decision block 390 and an egress filter block 306 in order to route incoming packets to a destination, as dictated by control plane 310. However, conventional network elements, such as network element 302, cannot provide varying QoS, as required by real-time applications.

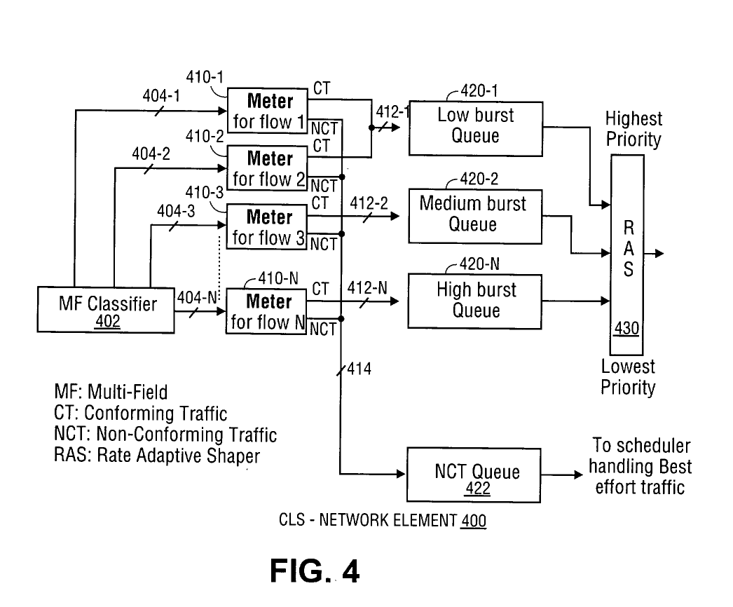

In other words, network element 302 is not configured to support INTSERV model services, such as guaranteed service, as well as controlled load service required for handling real-time applications, which exchange data via conventional networks, such as, for example, depicted in FIGS. 1 and 2. Therefore, network element 302 may be reconfigured utilizing the various functional datapath elements (DPE) provided by the differentiated services model in order to generate a controlled-load service (CLS) traffic conditioning block (TCB) within a network element to form a controlled load service network element 400, as depicted with reference to FIG. 4, in accordance with one embodiment of the present invention.

As illustrated with reference to FIG. 4, the CLS network element 400 may be utilized to replace conventional network elements 302, for example, as depicted with reference to FIG. 2, in order to provide controlled load service with a network 300, as depicted in FIG. 2. However, in contrast to network elements configured with INTSERV components to provide controlled load service, CLS network element 400 is configured utilizing DIFFSERV model datapath elements (DPE) to form the CLS-TCB contained therein. In one embodiment, DPEs include, but are not limited to, classifiers, meters, droppers, queues and schedulers.

Accordingly, in one embodiment, the CLS-TCB within the CLS network element 400 comprises a multi-field (MF) classifier 402. A classifier, according to the DIFFSERV model, represents a 1-in, N-out (fanout) element that splits a single incoming traffic stream into multiple outgoing streams. The classifier 402 comprises filters that match incoming packets and based on the matches, the packets are sent along different datapaths. For example, as depicted with reference to FIG. 4, the MF classifier 402 is configured to identify network traffic belonging to one of a plurality of flows receiving a contracted QoS (“QoS Flow(s)”), such as, for example, controlled load service.

Accordingly, when a packet belonging to a QoS flow is identified by MF classifier 402, the respective packet 404 (404-1, . . . , 404-N) is provided to a meter 410 (410-1, . . . , 410-N) configured according to a traffic specification (TSpec) of a respective flow to which the respective packet belongs. As illustrated, a DIFFSERV meter describes a 1-in, N-out element that measures incoming traffic and compares the incoming traffic to a rate profile. Based on the comparison, packets conforming to the rate profile (“conforming packets”) are sent out along various datapaths. As such, during QoS service set-up, such as, for example, utilizing a resource reservation protocol (RSVP), boomerang, YESSIR or the like, a meter is generated for each flow receiving a contracted QoS.

As illustrated with reference to FIG. 4, each meter 410 includes two outputs, a conforming traffic (CT) output, as well as a non-conforming traffic (NCT) output. As illustrated, non-conforming traffic 414 is provided to NCT queue 420; however, the conforming traffic 412 (412-1, . . . , 412-N) is provided to a respective queue 420 (420-1, . . . , 420-3) according to a burst level of the respective flow. As such, during initial service set-up, the various flows are analyzed to determine burst levels of the various flows. Once determined, in one embodiment, the burst levels can be divided into low burst levels, medium burst levels and high burst levels. Based on the division, a conforming traffic queue is generated for each burst level range.

For example, as illustrated with reference to FIG. 4, a low burst queue 420-1, a medium burst queue 420-2 and a high burst queue 420-3 are provided. As such, the meters 410 are utilized to ensure that non-conforming flows do not impact other flows and these flows continue to get the contracted QoS as long as they conform to their traffic specification. Likewise, utilizing the queues 420, the datapaths are set-up such that flows are segregated to different queues based on their advertised burstiness, as calculated by the ratio b/r, where b represents a bucket size (b) and r represents a token rate (r). As such, high burst flows will generally expect larger queueing delays, while low burst flows anticipate experiencing less queueing delays. Accordingly, in the embodiment depicted, segregating flows enables grouping of flows expecting equivalent delays together.

Finally, the packets output by the various queues 420 are passed on to a rate adaptive shaper (RAS) 420, which includes a maximum and minimum rate profile for each queue, set according to the aggregate of the TSpecs of the flows feeding into the respective queue. As such, in one embodiment, the RAS allows specifying thresholds for the monitored queues. Once the threshold is reached, this queue is serviced at a different rate. Consequently, the requirement of little or no average packet delay is met by ramping up the rate at which the queue is serviced once the occupancy exceeds a threshold.

Thus, when a burst is sent by a flow causing the threshold to be reached, the service rate is increased to quickly clear out the bursts. The various queues 420 were determined during protocol set-up according to the burst levels calculated for the various flows receiving controlled load service. In one embodiment, the separation of queues according to burst levels enables grouping of flows, such that flows that contain high burst levels generally expect higher queueing delays and are thereby grouped together, whereas flows experiencing low burst levels are likely to experience less queueing delays and therefore are grouped together. Consequently, the low burst quests 420-1 are given higher priority than the high burst queues 420-3 due to their respective, expected delays. Non-conforming traffic is given a lowest priority so that non-conforming traffic does not unfairly impact the best effort traffic.

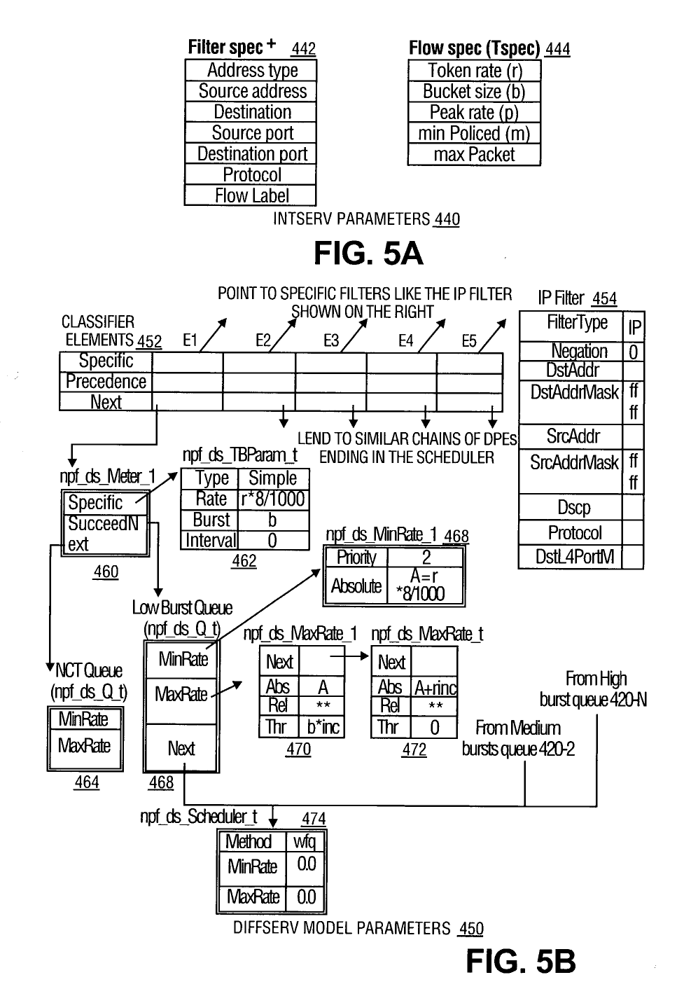

Referring now to FIGS. 5A and 5B, FIGS. 5A and 5B depict INTSERV model parameters 440 and corresponding DIFFSERV model parameters 450, which are mapped together within the CLS-TCB of the CLS network element 400, providing INTSERV controlled load service utilizing DIFFSERV building blocks. As illustrated with reference to FIG. 5A, the CLS filter spec 442 identifies packets belonging to a flow receiving CLS QoS. Accordingly, based on the filter specs, the MF classifier 402 monitors packets of respective flows to their respective meters. Likewise, as illustrated with reference to FIG. 5B, classifier element 452 contains various filters for identifying packets from received packet streams, as well as providing an indication of a meter to which the respective packets should be transferred, as illustrated with reference to block 460.

Furthermore, the various parameters are mapped to the NCT queue 464 or the low burst queue 466, high burst queue or medium burst queue (not illustrated). The various tables illustrate the min rate and max rate, at which the scheduler services each of the queues. The aggregate of the rates of each flow that feeds into a queue is used to calculate the absolute rate for the queue. Once calculated, the rate adaptive behavior of RAS 430 is achieved by, in one embodiment, having an administrator set a specified threshold (a percentage of the aggregate bucket size for the queue) of a max rate structure 470 and chaining it with another max rate structure 472 with the higher rate for which the scheduler services the queue once the threshold is reached.

In one embodiment, the minimum and max rate are determined according to Table 468, such that packets are serviced at an absolute rate (A), which is determined from an INTSERV rate (r), which is defined in units of kilobits per second. Accordingly, the INTSERV rate (r) is converted into DIFFSERV units of bytes per second according to the following formula:

A=r×8÷1,000 (1)

as indicated by Table 468. Likewise, the rate adaptive shaping may be performed as indicated by Table 470 at the absolute rate (A). However, the threshold value (b*inc) may indicate a bucket occupancy percentage, such as, for example 75%. Accordingly, when the bucket occupancy threshold level is reached, as indicated by Table 472, the queue may be serviced at an increased rate by adding an incremented rate value (rinc) according to the following formula:

ABS=A+rinc (2)

As such, once the current bucket size of the queue is below the threshold level (b*inc), the queue is once again serviced at the absolute rate (A).

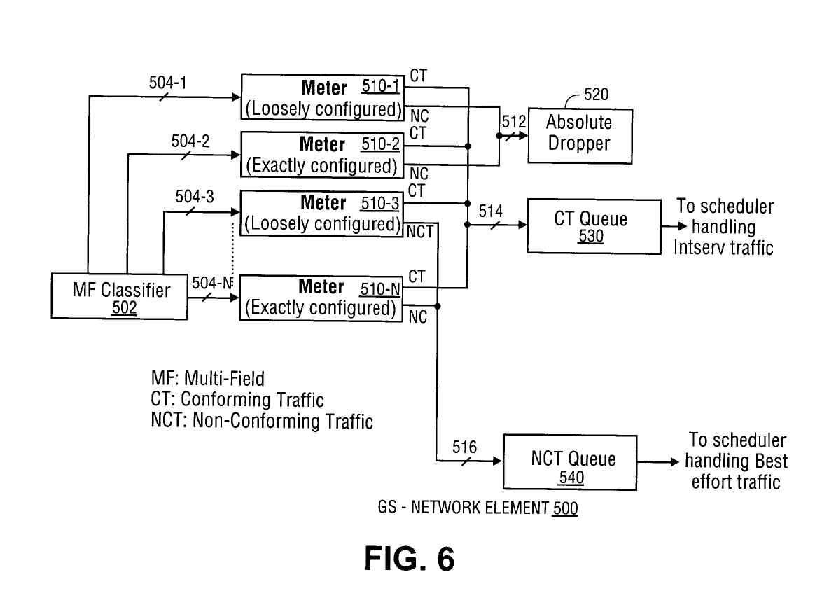

Referring now to FIG. 6, FIG. 6 depicts a guaranteed service (GS) network element 500, which may be utilized within a network, such as network 300, as depicted in FIG. 2, in order to provide end-to-end guaranteed service for flows requiring assured bandwidth and delay bounds. Accordingly, traffic utilizing GS has strict bandwidth and delay guarantees. As a result, it is necessary that the traffic conform to a traffic profile. Generally, GS traffic is policed at the ingress router according to the token bucket specification and shaped at the core routers. An important aspect of the GS implementation is the fact that GS element 500 exports error terms characterizing the delay introduced in a flow by the respective network element.

In one embodiment, the delay values exported by the various network elements are utilized by a receiver of the real-time application to calculate the bandwidth to reserve in order to achieve a targeted queueing delay. In one embodiment, an administrator determines these error terms beforehand by examining specific network setup and testing the various network element devices. Accordingly, a GS-TCB is created within GS network element 500, which includes a MF classifier 502, which routes incoming packets belonging to a flow receiving GS QoS to a respective meter 510 (510-1, . . . , 510-N). As such, the various identified packets are fed into meters 510 that monitor the flows to ensure conformance to relevant TSpec. However, while invoking the contracted service for a flow, it is indicated whether the flow should be strictly metered or not.

In one embodiment, flows that begin at a network element are strictly metered to their TSpec. Whereas, flows that have been admitted into the network by an earlier element are not strictly metered as queueing effects will occasionally cause a flow's traffic that entered a network as conforming to be no longer conforming. In one embodiment, the values indicated by a flow's TSpec may be modified while configuring the meter parameters in order to incorporate a network path delay to enable loose metering. Accordingly, each meter includes a conforming traffic (CT) output, as well as a non-conforming traffic (NCT) output. The conforming traffic 514 is provided to a CT queue 530, whereas the non-conforming traffic is either provided to NCT queue 540 or absolute dropper 520. This is because, when invoking the service, it can be specified whether non-conforming traffic packets should be dropped or relegated to best effort.

In one embodiment, an absolute dropper 520 is fed non-conforming packets when the specified service action is to drop the non-conforming packets. In contrast, non-conforming traffic packets 516 are provided to NCT queue 540 in accordance with the service actions dictating that non-conforming traffic is relegated to best effort service. The non-conforming traffic queue 540 is given a lower priority than the best effort traffic to ensure that the non-conforming traffic does not impact best-effort traffic.

In contrast, all conforming traffic is fed into CT queue 530. Care is taken to ensure that, when a flow is added, the CT queue can handle it. However, if adding an additional flow to CT queue 530 will exceed a maximum queue size of the CT queue 530, the flow may be handled by a new traffic conditioning block (TCB) so that its packets go into a queue in the new TCB, therefore ensuring that there is no packet lost due to overflow. Finally, the output from the queues is fed into a scheduler with a maximum rate profile and minimum rate profiles set according to aggregates of the TSpecs for each flow.

In one embodiment, NCT traffic 516 fed into NCT queue may be buffered according to a network path delay in order to enable non-conforming traffic to become, once again, conforming. In one embodiment, this is achieved by delaying the non-conforming packets long enough so that the traffic conforms once forwarded. In one embodiment, this requires extra queue space, as even the non-conforming packets need to be stored. In one embodiment, the amount of extra traffic is determined by the error terms. In one embodiment, the error terms include fixed delay (D), which is expressed in microseconds and includes latency in getting a packet from the input to the output interface, in addition to latency caused by shared bandwidth, as well as any time required to process routing update. Likewise, the error terms also include data backlog (C), which is expressed in bytes.

A GS flow is described by the source in a token bucket traffic specification, or TSpec. In response, the network elements set aside the required resources to handle the flow. The elements also export how much they deviate from the fluid model with the error terms C and D. In one embodiment, the TSpec and the aggregated values of the error terms elements in the path are finally delivered to a receiver, utilizing, for example, a set-up protocol (e.g., RSVP). With this information, the receiver decides how much bandwidth to actually reserve, utilizing a reservation specification (RSpec), which includes a requested bandwidth (R), which is sent back towards the sender. In one embodiment, the aggregate error terms allow the receiver to determine the queueing delay along the entire path:

fluid rate(b/R)+rate dependent deviation(C_{TOT}/R)+rate independent deviation(D_{TOT}) (3)

In one embodiment, when the path delay is less than what is desired by the receiver, the receiver can inform network elements of the difference via a slack term (S):

S=desired delay−expected delay (4)

Accordingly, a network element can use this slack term to reduce its allocation for the flow when desired. Consequently, in one embodiment, using the parameters TSpec, RSpec, C, D and the slack terms, GS provides a strict mathematical assurance of both bandwidth, throughput and queueing delay, enabling applications, such as audio/video playback streams.

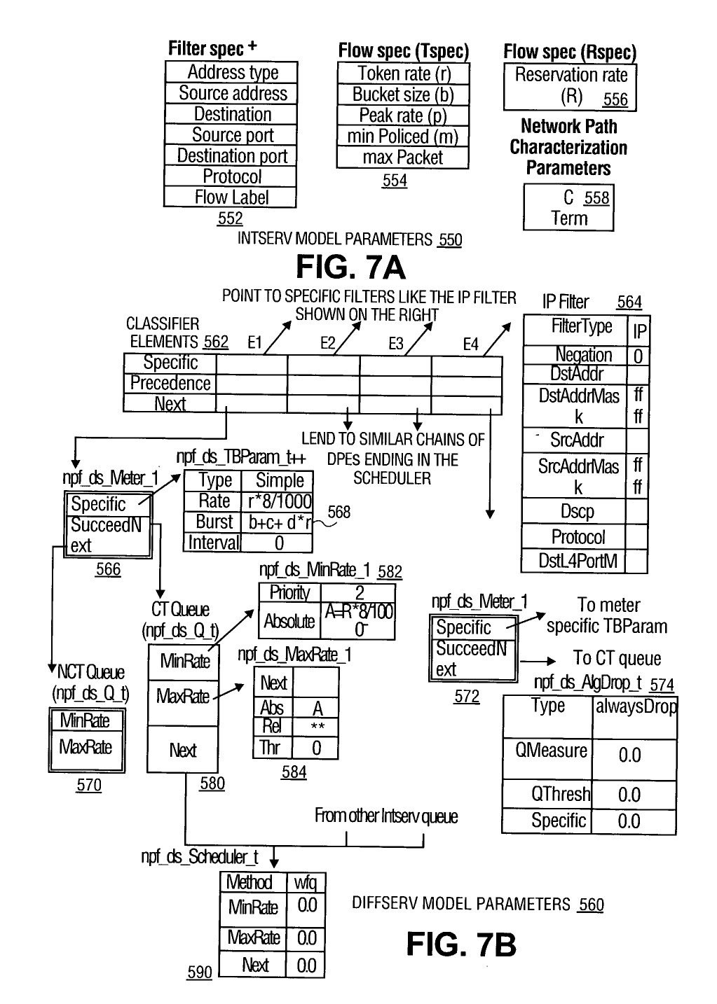

Referring now to FIGS. 7A and 7B, FIGS. 7A and 7B depict INTSERV parameters 550, which are mapped to DIFFSERV parameters 560 to enable guaranteed service within a GS-TCB of the network element utilizing DIFFSERV modules. As illustrated, mapping of the GS filter spec is done in the same manner as performed for the CLS filter spec, as depicted with reference to FIGS. 5A and 5B. In one embodiment, when the service action requires strict metering of flows, the TB parm structure 568 is set-up using the TSpec token rate (r) and bucket size (b). In contrast, if the service action specifies loose metering, the TB parm structure 568 that parameterizes the meters is configured using error terms (C and D) in addition to the token rate (r) and the bucket size of the TSpec. Likewise, the min rate and max rate structures 582 and 584 are utilized to determine the rate at which the downstream scheduler services the queues containing conforming GS traffic, which are set according to the reservation rate (r). Furthermore, NCT traffic is either dropped or relegated to best effort traffic, as indicated by service action 574.

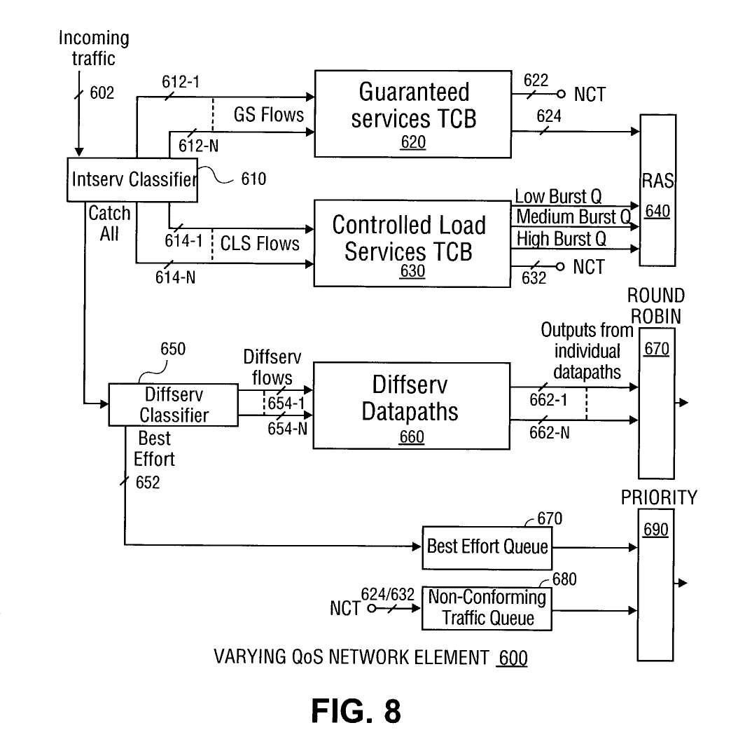

Referring now to FIG. 8, FIG. 8 depicts a block diagram illustrating a varying QoS network element 600, configured to support flows receiving guaranteed service QoS, controlled load service QoS, DIFFSERV datapaths, and best effort traffic. As illustrated, an INTSERV classifier 610 determines the flows receiving either controlled load service or guaranteed service, which are provided to guaranteed service TCB 620 or controlled load services TCB 660. Otherwise, the traffic 604 is transmitted to DIFFSERV classifier 650, which identifies DIFFSERV flows, which are provided to DIFFSERV datapath 620. Otherwise, the traffic is identified as best effort traffic 652 and provided to best effort queue 670.

In one embodiment, guaranteed services TCB 620 is configured in accordance with GS-TCB utilized within GS network element 500, as depicted with reference to FIG. 6. Likewise, controlled load services TCB 630 is configured in accordance with the CLS-TCB utilized within CLS network element 400, as depicted with reference to FIG. 4. Accordingly, the network element 600, as depicted in FIG. 8, is able to process traffic, including a mixture of INTSERV, DIFFSERV and best effort flows, that pass through the same network element without stamping on each other. In one embodiment, this is achieved by partitioning the available bandwidth among these broad classes of traffic.

The outputs from the GS-TCB 620 is given the highest priority, as it has the strictest demands. Likewise, DIFFSERV traffic is handled by the specific datapaths within the DIFFSERV block 660 that have been set up. The outputs from the individual datapaths are fed into a round robin scheduler 670, thereby ensuring that each flow gets a fair share of the bandwidth, as it has been set aside for DIFFSERV traffic. The non-conforming traffic from the various INTSERV flows is collected in a separate queue. This traffic is fed into a priority scheduler 690, which also services best effort traffic. The best effort traffic is serviced at a higher priority so that the non-conforming traffic is only serviced if there is no best effort traffic.

Finally, all the traffic is fed into a Weighted Fair Queueing scheduler, not shown. The scheduler is set-up with weights reflecting the percentage of bandwidth that is allocated to each kind of traffic. However, when pre-allocated bandwidth is not used, the scheduler will distribute the available bandwidth among remaining classes that require transmission of data. Accordingly, when there is no INTSERV or DIFFSERV traffic, all bandwidth is available for best effort flows. Procedural methods for implementing the various embodiments of the present invention are now described.

Operation

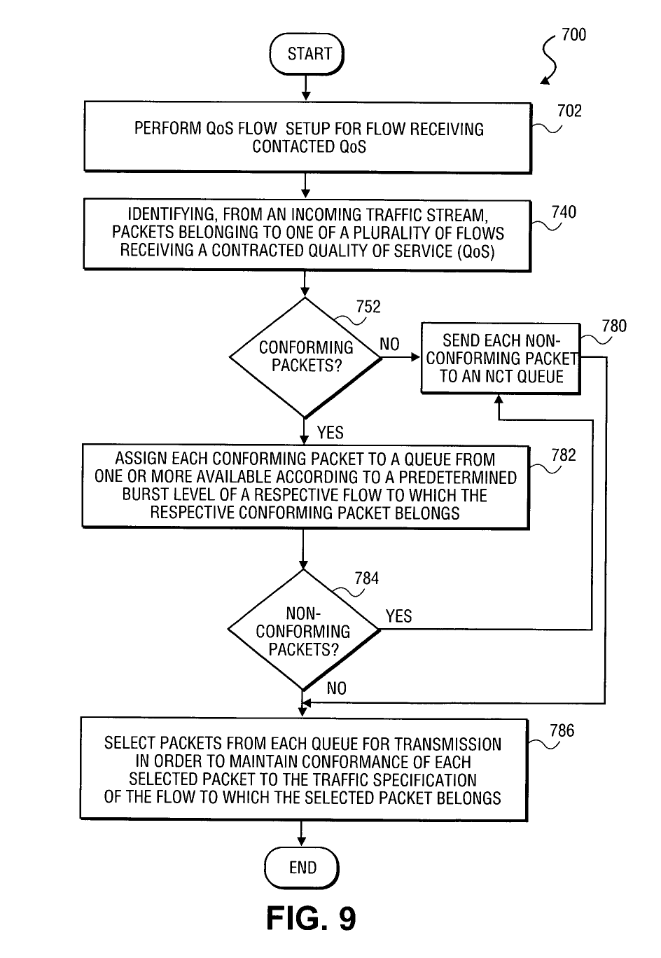

Referring now to FIG. 9, FIG. 9 depicts a flowchart illustrating a method 700 for providing controlled load quality of service within a network element utilizing differentiated services (DIFFSERV) building blocks, for example, as depicted with reference to FIG. 4 and in accordance with one embodiment of the present invention. At process block 702, flow quality of service set-up is performed for each flow receiving a contracted quality of service. At process block 740, packets belonging to one of a plurality of flows receiving a contracted QoS are identified from an incoming traffic stream. In one embodiment, this is performed utilizing a multi-field classifier, for example, as depicted with reference to FIG. 4.

Once identified, at process block 752, it is determined whether the respective identified packets conform to a predetermined traffic specification for a respective flow to which the respective packet belongs. In one embodiment, this may be performed utilizing a DIFFSERV meter, configured according to a traffic specification for a respective flow assigned to the meter. Next, at process block 782, each conforming packet is assigned to a queue from one or more available queues according to a burst level of a respective flow to which the respective conforming packet belongs.

Once each conforming packet is assigned to a queue according to the packet burst level, process block 784 is performed. At process block 784, it is determined whether any of the identified packets do not conform to the predetermined traffic specification. When non-conforming packets are detected, process block 780 is performed. At process block 780, each non-conforming packet is sent to a non-conforming traffic queue, for example, NCT queue 422, as depicted in FIG. 4. Finally, at process block 786, packets are selected from each queue for transmission in order to maintain conformance of each selected packet to the predetermined traffic specification for a respective flow to which the respective selected packet belongs.

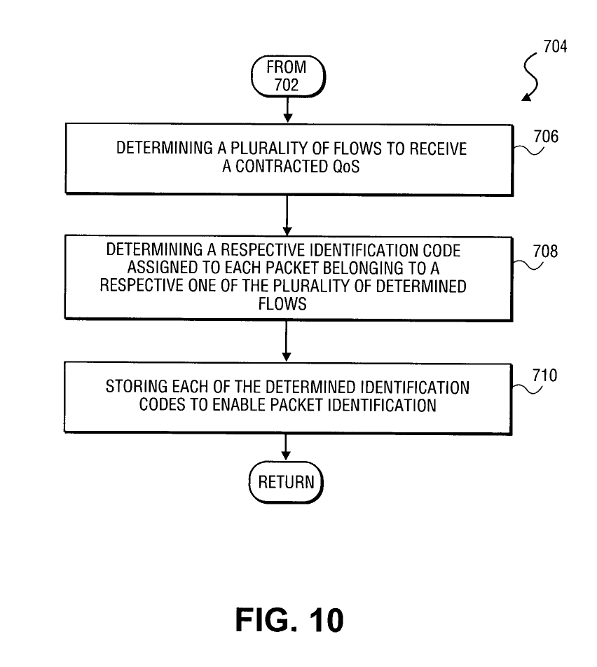

Referring now to FIG. 10, FIG. 10 depicts a flowchart illustrating a method 704 performed during QoS flow set-up and prior to packet identification of process block 740, in accordance with a further embodiment of the present invention. At process block 706, a plurality of flows to receive a contracted QoS are determined. In one embodiment, the QoS is controlled load service. Once determined, at process block 708, respective identification codes (Flow ID, Queue ID) assigned to and contained within each packet's meta-data belonging to a respective one of the plurality of determined flows are ascertained. Finally, at process block 710, each of the determined identification codes are stored to enable patent identification within, for example, the multi-field classifier 402, as depicted in FIG. 4, utilizing, for example, a set-up protocol, such as resource reservation protocol (RSVP), boomerang, YESSIR or the like.

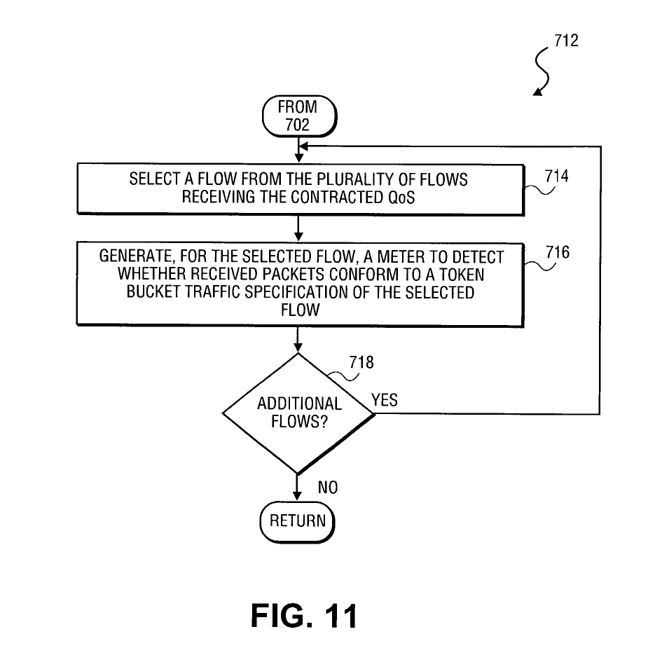

Referring now to FIG. 11, FIG. 11 depicts a flowchart illustrating a method 712 performed during QoS service set-up and prior to packet identification of process block 740, as depicted in FIG. 9, in accordance with a further embodiment of the present invention. At process block 714, a flow is selected from a plurality of flows receiving the contracted QoS. Once selected, at process block 716, a meter is generated for the selected flows to detect whether packets belonging to the selected flow conform to a token bucket traffic specification of the selected flow. Finally, at process block 718, process blocks 714 and 716 are repeated for each flow receiving contracted QoS. In one embodiment, this is performed during protocol set-up to enable metering of received flows to ensure conformance with a traffic specification or TSpec of the respective flow.

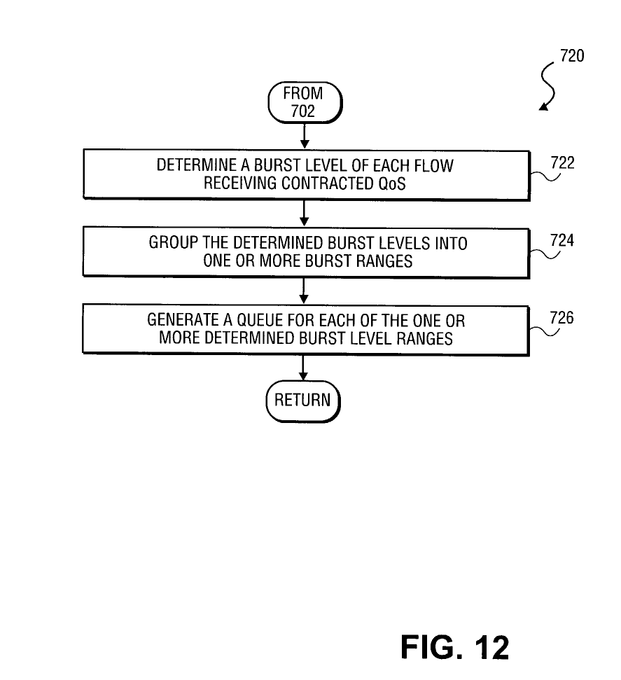

Referring now to FIG. 12, FIG. 12 depicts a flowchart illustrating an additional method 720 during QoS service set-up and prior to packets identification of process block 740, as depicted with reference to FIG. 9, and in accordance with the further embodiment of the present invention. Accordingly, at process block 722, a burst level of each flow receiving contracted QoS is determined. Once determined, the various burst levels are grouped into one or more burst level ranges at process block 724. Finally, at process block 726, a queue is generated for each of the one or more burst level ranges. For example, as depicted with reference to FIG. 4, the burst level ranges include a low burst level, a medium burst level and a high burst level. In one embodiment, a low burst queue 410-1, high burst queue 410-3 and medium burst queue 410-2 are generated for TCB interface in order to segregate the different packets according to their advertised burstiness during TCB interface initialization.

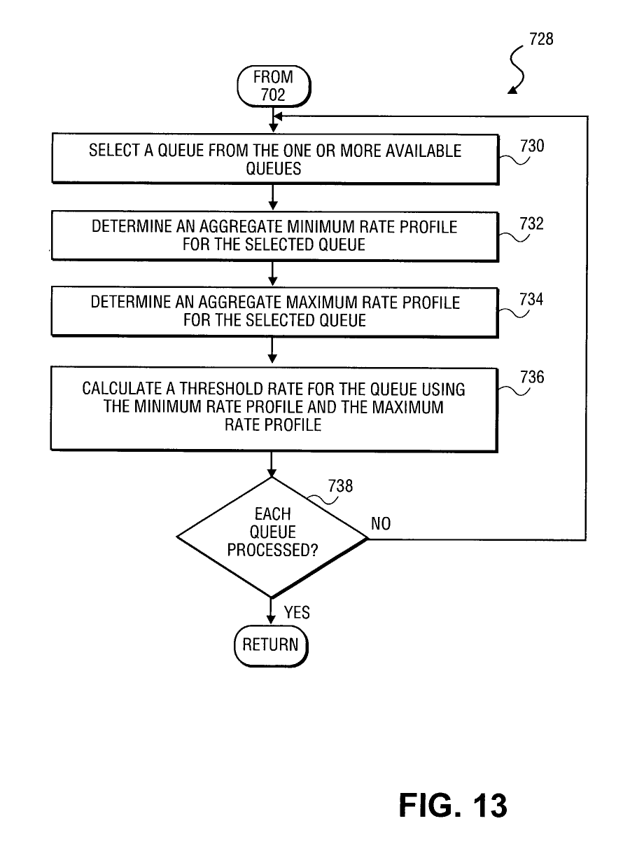

Referring now to FIG. 13, FIG. 13 depicts a flowchart illustrating a method 728 performed during QoS service set-up and prior to packet identification at process block 740, as depicted in FIG. 9, in accordance with a further embodiment of the present invention. At process block 730, a queue is selected from the one or more available queues. Once selected, at process block 732, an aggregate minimum rate profile is determined for the selected queue. Once determined, at process block 734, an aggregate maximum rate profile is determined for the selected queue.

Next, at process block 736, a threshold rate for the queue is calculated using the minimum rate profile and the maximum rate profile. Once a threshold is calculated, at process block 738, process blocks 730-736 are repeated for each of the one or more available queues. Accordingly, calculation of the threshold rate during QoS setup enables transmitting of packets received from the one or more queues according to a current threshold level of each queue in view of the calculated threshold level of the respective queue, utilizing for example, rate adaptive shaper (RAS) 430, as depicted with reference to FIG. 4. Accordingly, the queue threshold is set up during initial QoS flow set-up. In contrast, the queue occupancy is calculated on the fly as packets come into each of the available queues. As such, the occupancy is compared with the threshold, and if exceeded, the rate at which the RAS 430 services this queue is bumped up by, for example, an amount configured at flow set-up time by the operator.

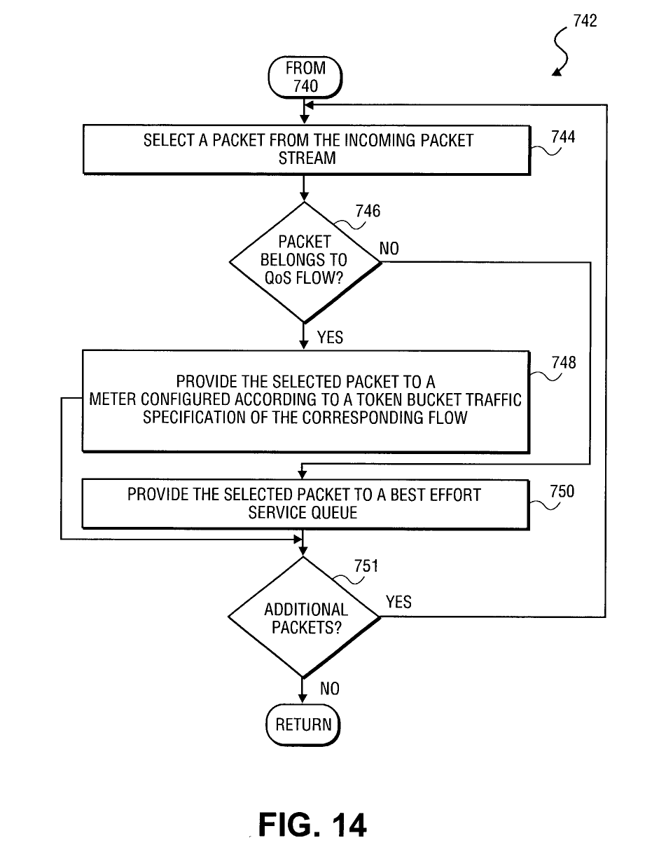

Referring now to FIG. 14, FIG. 14 depicts a flowchart illustrating an additional method 742 for identification of packets of process block 740, as depicted in FIG. 9, in accordance with a further embodiment of the present invention. At process block 744, a packet is selected from the incoming packet stream. Once selected, it is determined whether the selected packet contains one or more identification codes corresponding to a flow receiving contracted QoS. When such is detected, at process block 746, the selected packet is provided to a meter configured according to a token bucket traffic specification of the corresponding flow to which the packet belongs, such as, for example, meters 410, as depicted with reference to FIG. 4. Otherwise, the selected packet is provided to a best effort service queue at process block 748. Finally, process blocks 744-750 are repeated for each packet within the incoming packet stream at process block 751.

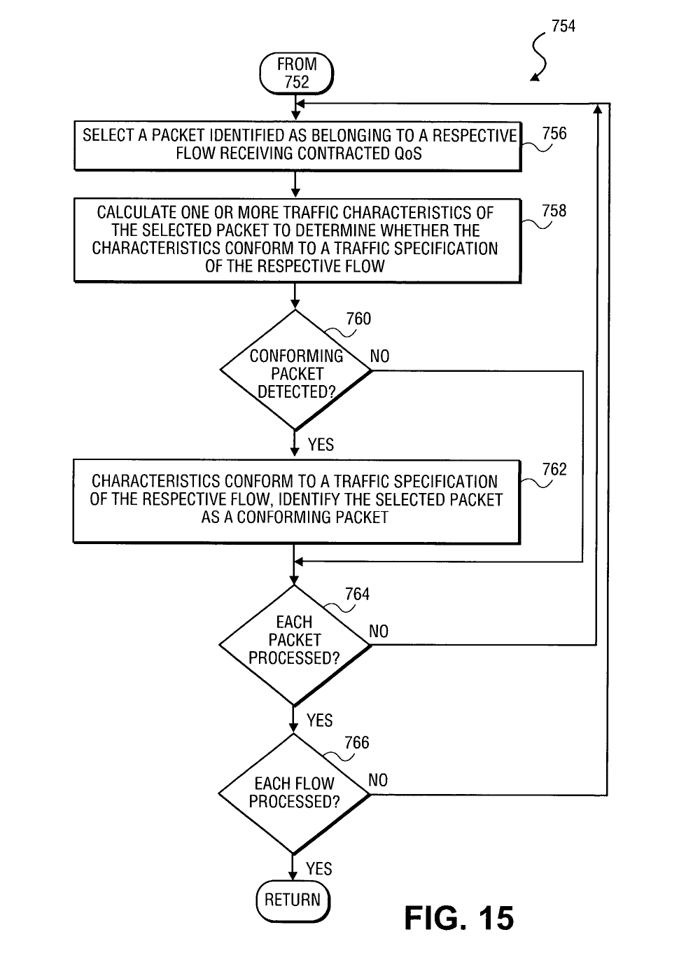

Referring now to FIG. 15, FIG. 15 depicts a flowchart illustrating an additional method 754 for determining conforming packets of process block 752, as depicted in FIG. 9, in accordance with the further embodiment of the present invention. At process block 756, a packet identified as belonging to a respective flow receiving contracted QoS is selected. Once selected, at process block 758, one or more traffic characteristics of the selected flow are calculated. Next, at process block 760, when the one or more calculated traffic characteristics conform to a traffic specification of the respective flow, at process block 762, the selected packet is identified as a conforming packet. Otherwise, the packet is identified as a non-conforming packet.

Accordingly, at process block 764, process blocks 756-762 are repeated for each packet belonging to a respective flow receiving contracted QoS. Finally, at process block 766, process blocks 756-764 are repeated for each of the plurality of flows receiving contracted QoS. For example, as depicted with reference to FIG. 4, each meter 410 contains two outputs, a conforming traffic (CT) output, as well as a non-conforming traffic (NCT) output. As illustrated, each packet belonging to a flow receiving contracted QoS is either identified as a CT packet 412 or an NCT packet 414.

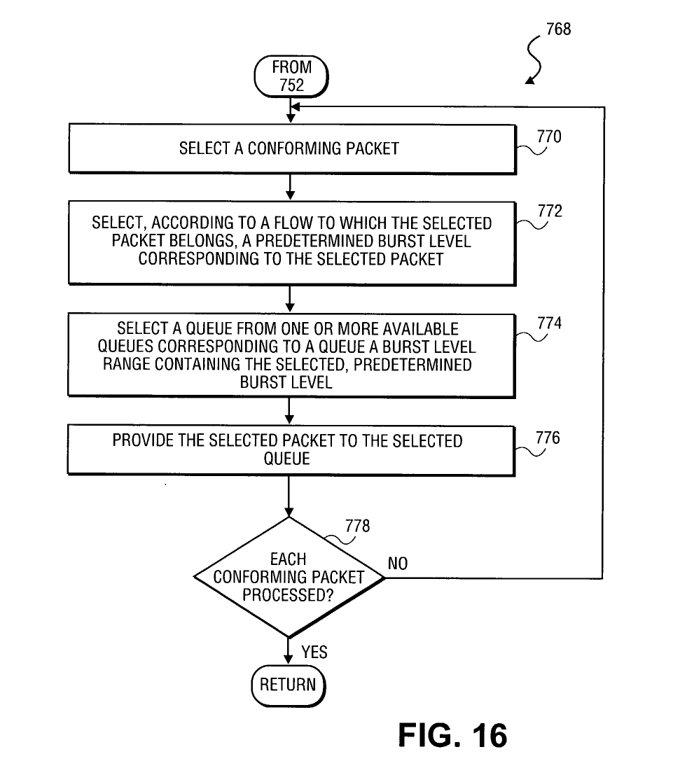

Referring now to FIG. 16, FIG. 16 depicts a flowchart illustrating an additional method 768 for assigning conforming packets to a respective queue of process block 752, as depicted in FIG. 9, in accordance with a further embodiment of the present invention. At process block 770, a conforming packet is selected from a plurality of identified conforming packets. Once selected, at process block 772, a predetermined burst level is selected corresponding to the selected packet according to a flow to which the selected packet belongs. Once selected, at process block 774, a queue from one or more available queues corresponding to a burst level range containing the selected predetermined burst level, is selected. Once selected, at process block 776, the selected packet is provided to the selected queue. In one embodiment, assignment to a queue is performed according to a Queue ID indicated with a packet's meta-data and assigned during QoS flow set-up.

Finally, at process block 778, process blocks 770-776 are repeated for each conforming packet. For example, as illustrated with reference to FIG. 4, the CLS network element 400 includes a low burst level queue, a medium burst level queue and a high burst level queue 420. The various queues 420 were determined during protocol setup according to the burst levels calculated for the various flows receiving controlled load service. In one embodiment, the separation of queues according to burst levels enables grouping of flows according to their burst level, such that flows that contain high burst levels generally expect higher queueing delays and are thereby grouped together, whereas flows experiencing low burst levels are likely to experience less queueing delays and therefore are grouped together.

In other words, the various datapaths are set-up such that flows are segregated to different queues based on their advertised burstiness as calculated by the ratio b/r where r represents the token rate and b represents the bucket size. As such, high burst flows with a large ratio of bucket size to token rate expect more queueing delay while low burst flows expect to experience less queueing delay. Thus, the idea behind segregating flows based on burstiness is to group flows expecting equivalent together.

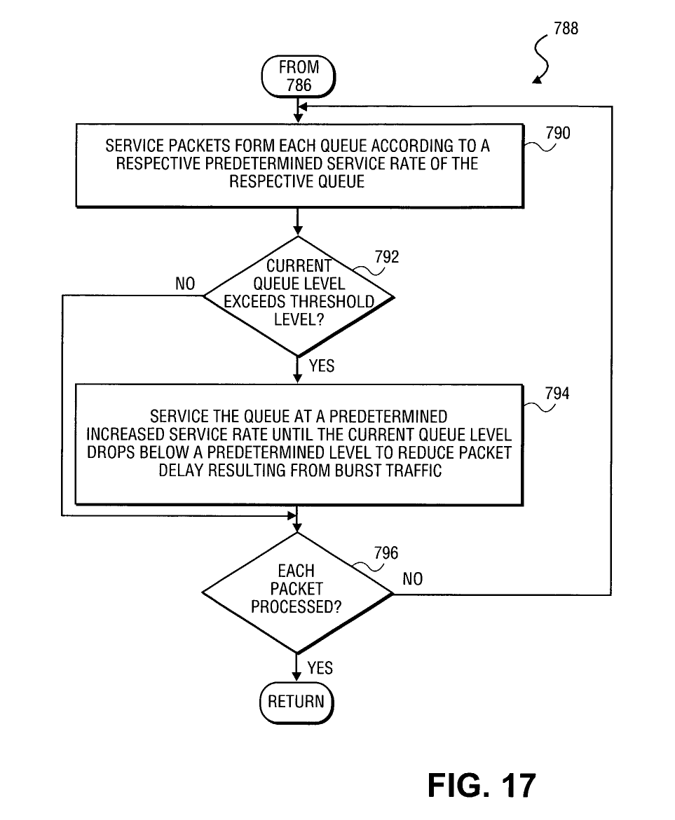

Referring now to FIG. 17, FIG. 17 depicts a flowchart illustrating an additional method 788 for selecting packets at process block 786, as depicted in FIG. 9, in accordance with the further embodiment of the present invention. At process block 790, packets are serviced from each queue according to a respective predetermined service rate of the respective queue. Next, at process block 792, when a current queue level of the respective queue exceeds predetermined threshold level for the respective queue, process block 794 is performed. At process block 794, the queue is serviced at a predetermined increased service rate until the current queue level drops below a predetermined level to reduce packet delay resulting from burst traffic. Finally, at process block 796, process blocks 790-794 are repeated for each packet contained with the one or more available queues 410. In one embodiment, this is performed utilizing RAS module 430, as depicted with reference to FIG. 4.

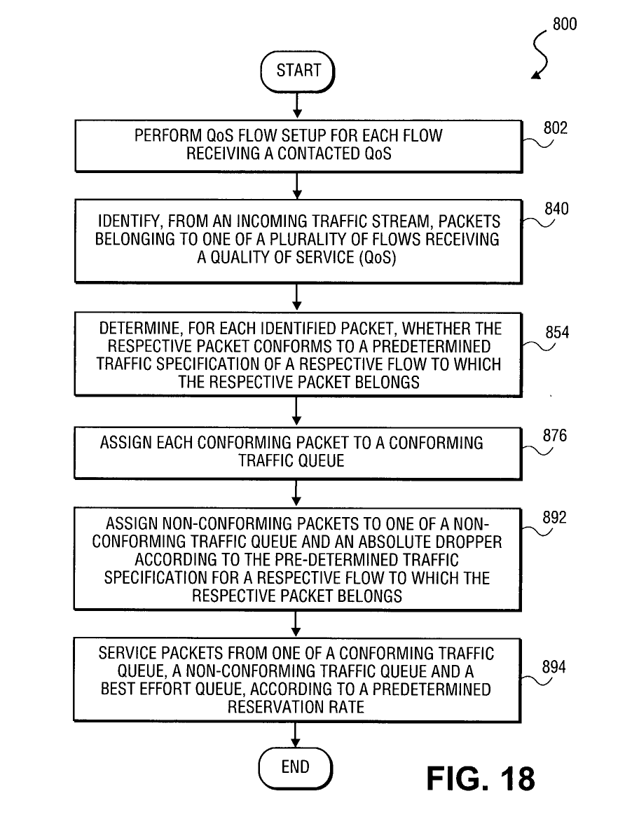

Referring now to FIG. 18, FIG. 18 depicts a flowchart illustrating a method 800 for providing guaranteed service within a network element utilizing DIFFSERV building blocks, for example, as depicted with reference to FIG. 6, and in accordance with one embodiment of the present invention. At process block 802, QoS flow set-up is performed for each flow receiving a contracted quality of service, or QoS. At process block 840, packets belonging to one of a plurality of flows receiving a contracted QoS are identified. Once identified, at process block 854, it is determined, for each identified packet, whether the respective identified packet conforms to either a predetermined traffic specification for respective flow to which the respective packet belongs or a modified traffic specification according to a predetermined network path delay.

Once determined, at process block 876, each conforming packet is assigned to a conforming traffic queue. Otherwise, at process block 892, the non-conforming packets are assigned to one of a non-conforming traffic queue and an absolute dropper according to the predetermined traffic specification for the respective flow to which the respective non-conforming packet belongs. Finally, at process block 894, packets are serviced from one of a conforming traffic queue, a non-conforming traffic queue and a best effort queue, according to a predetermined reservation rate.

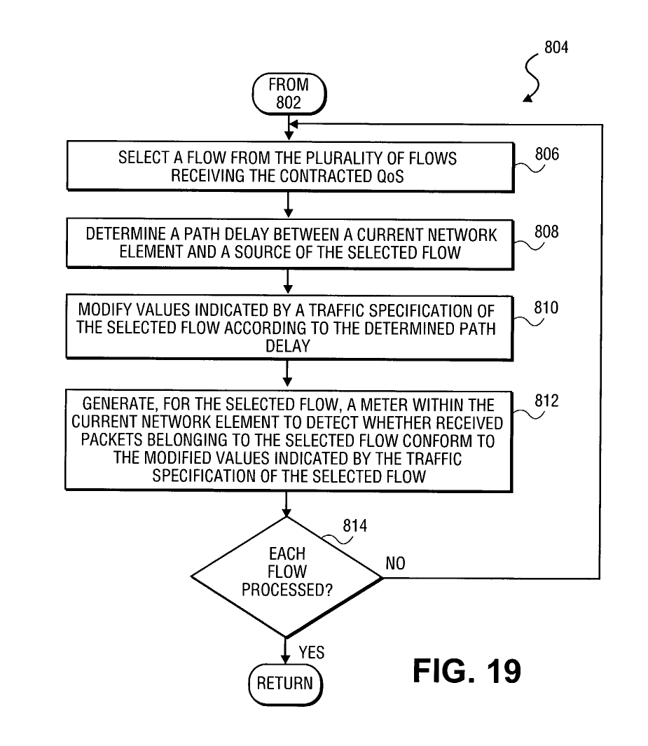

Referring now to FIG. 19, FIG. 19 depicts a flowchart illustrating an additional method 804 during QoS service set-up (block 802) and prior to identifying packets at process block 840, as depicted in FIG. 18, and in accordance with the further embodiment of the present invention. At process block 806, a flow is selected from the plurality of flows receiving contracted QoS. Once selected, at process block 808, a path delay between a current network element and a source of the selected flow is determined. Once the path delay is determined, at process block 810, a traffic specification of the selected flow is modified according to the determined path delay. Once modified, at process block 812, a meter is generated for the selected flow within the current network element (or TCB) to detect whether packets belonging to the selected flow conform to the modified traffic specification of the selected flow. Finally, at process block 814, process blocks 806 through 812 are repeated for each of the plurality of flows receiving contracted QoS.

Accordingly, as depicted with reference to FIG. 6, the GS network element 500 includes meters 510, which either are loosely configured according to the modified traffic specification, performed in accordance with method 816 or metered for exact conformance to flow's traffic specification. In one embodiment, QoS service set-up determines whether a respective flow should be loosely metered or exactly metered (service action). Generally, flows that have been admitted into the network by an earlier network element are not strictly metered as queueing effects will occasionally cause a flow's traffic that entered the flow as conforming to no longer conform to a traffic specification. Accordingly, the TSpec is modified to include the path delay for performing detection of flow conformance.

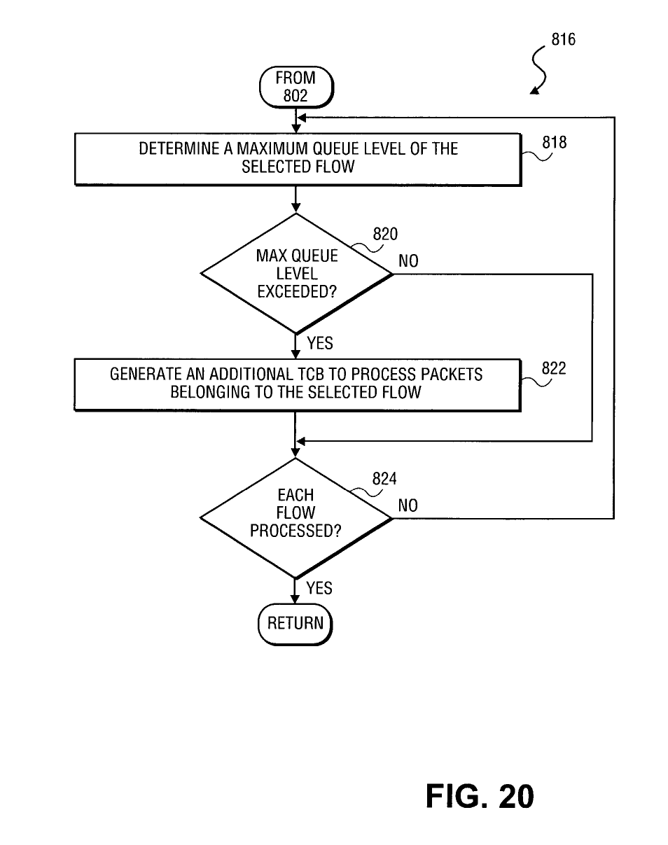

Referring now to FIG. 20, FIG. 20 depicts a flowchart illustrating an additional method 816 performed during protocol service set-up and prior to assigning conforming packets to the CT queue 530, as depicted in FIG. 6, in accordance with the further embodiment of the present invention. At process block 818, a maximum queue level of the selected flow is determined. Next, at process block 820, it is determined whether the maximum queue level exceeds a queue level of the CT queue 530 (FIG. 6). When such is the case, process block 822 is performed, where an additional GS-TCB is generated within the network element to process packets belonging to the selected flow. Finally, at process block 824, process block 818-822 are repeated for each of the plurality of flows requesting contrasting QoS.

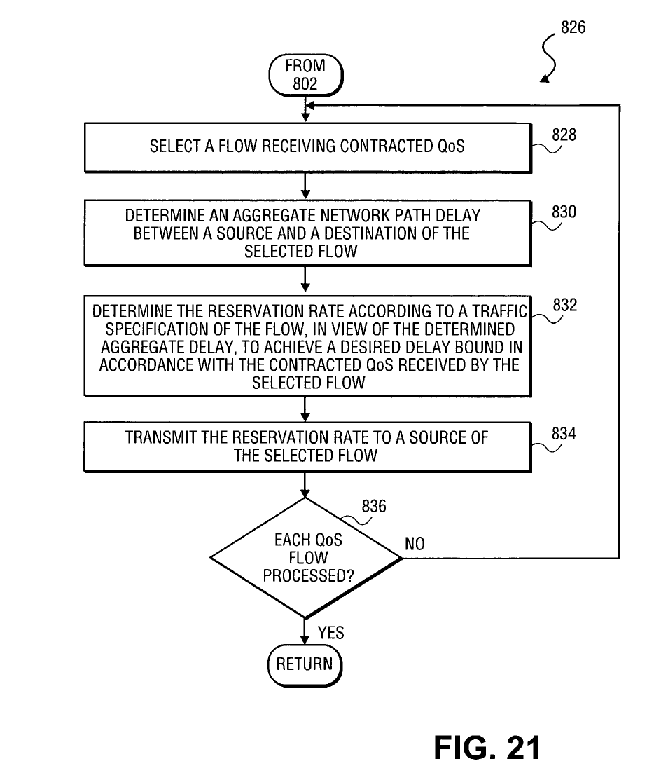

Referring now to FIG. 21, FIG. 21 depicts a flowchart illustrating an additional method 826 performed during QoS flow set-up at process block 802, as depicted with reference to FIG. 18. At process block 828, a flow is selected from the plurality of flows receiving contracted QoS. Once selected, at process block 830, an aggregate network path delay (determined during reservation set-up) between a source and a destination of the selected flow is selected. Once determined, at process block 832, a reservation rate is determined by the flow destination (receiver) according to a traffic specification of the flow in view of the determined path delay to achieve a desired delay bound in accordance with the contracted QoS received by the selected flow (See Equations 3 and 4 above). Once acquired, at process block 834, the reservation rate is transmitted to a source of the selected flow. Finally, at process block 836, process blocks 828-834 are repeated for each flow receiving contracted QoS.

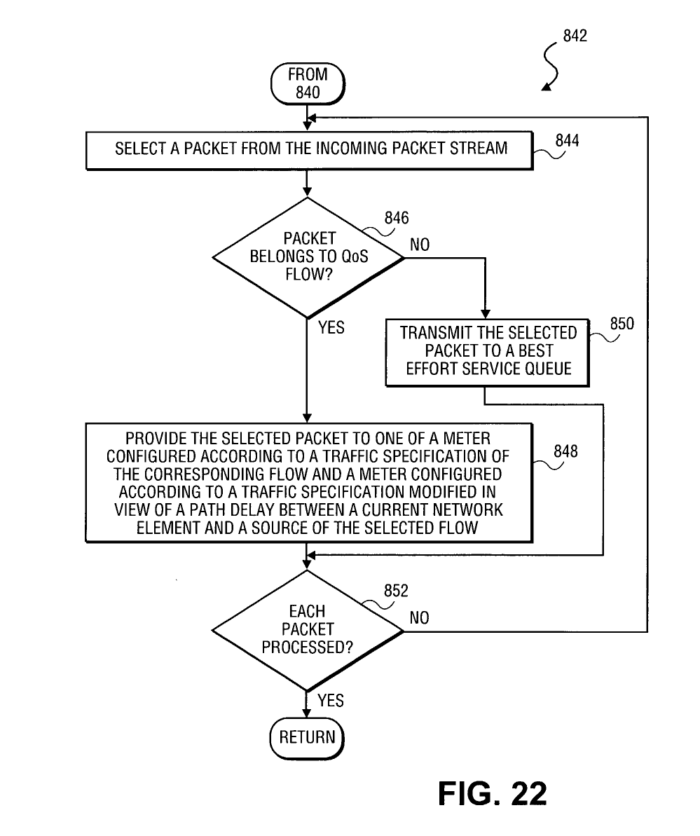

Referring now to FIG. 22, FIG. 22 depicts a flowchart illustrating a method 842 for identifying packets at process block 840, as depicted in FIG. 18, in accordance with one embodiment of the present invention. At process block 844, a packet is selected from the incoming packet stream. Next, at process block 846, when meta-data of the selected packet includes one or more identification codes corresponding to a flow receiving contracted QoS, process block 848 is performed. At process block 848, the selected packet is provided to a meter configured according to a traffic specification of the corresponding flow. Otherwise, at process block 850, the selected packet is transmitted to a best effort queue. Finally, at process block 852, process blocks 844-850 are repeated for each packet within the incoming packet stream. For example, as depicted with reference to FIG. 6, MF classifier 502 utilizes a filter spec 564, as depicted in FIG. 7A, in order to identify packets belonging to one of a plurality of flows receiving guaranteed service.

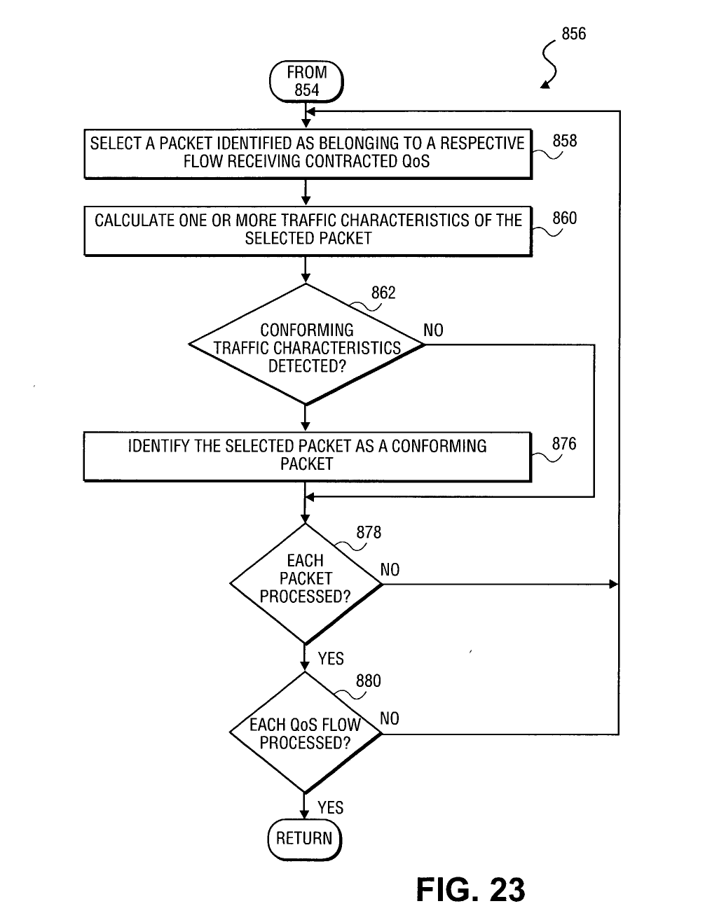

Referring now to FIG. 23, FIG. 23 depicts a flowchart illustrating a method 856 for determining packet conformance at process block 854, as depicted with reference to FIG. 18 and in accordance with the further embodiment of the present invention. At process block 858, a packet is selected, which is identified as belonging to a respective flow receiving contracted QoS. Once selected, at process block 860, one or more traffic characteristics of the selected packet are calculated. Next, at process block 862, it is determined whether the one or more calculated traffic characteristics conform to a traffic specification of the respective flow, which might have been modified according to a path delay. When such is the case, at process block 876, the selected packet is identified as a conforming packet.

Otherwise, the packet is identified as a non-conforming packet. Next, at process block 878, process blocks 858-876 are repeated for each packet identified as belonging to a flow receiving contracted QoS. Finally, at process block 886, process blocks 858-878 are repeated for each flow receiving contracted QoS. In one embodiment, calculation of the traffic characteristics is performed utilizing meters 510, which may be performing loose conformance detection from TSpecs values modified in accordance with a path delay or strict conformance detection in accordance with the TSpec of the respective flow to which the packet belongs.

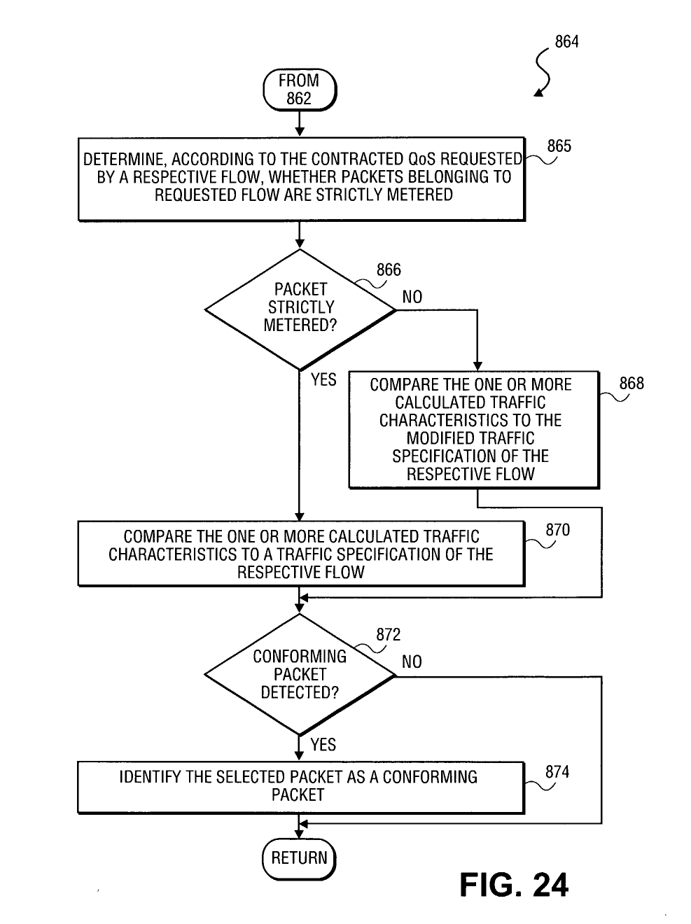

Referring now to FIG. 24, FIG. 24 depicts a flowchart illustrating an additional method 864 for identification of conforming packets of process block 862, as depicted with reference to FIG. 23. At process block 865, it is determined according to the contracted QoS requested by a respective flow whether the flow requires strict metering (service action). At process block 866, when the flow requires strict metering, process block 870 is performed. At process block 870, the one or more calculated traffic characteristics are compared to a traffic specification of the respective flow.

Otherwise, the one or more calculated traffic characteristics are conformed to a modified traffic specification of the respective flow at process block 868. Next, at process block 870, it is determined whether the calculated traffic characteristics conform to either the traffic specification or the modified traffic specification. When such is the case, process block 874 is performed, wherein the packet is identified as a conforming packet. Otherwise, the packet is deemed non-conforming and will be relegated to the NCT queue 540, as depicted with reference to FIG. 6.

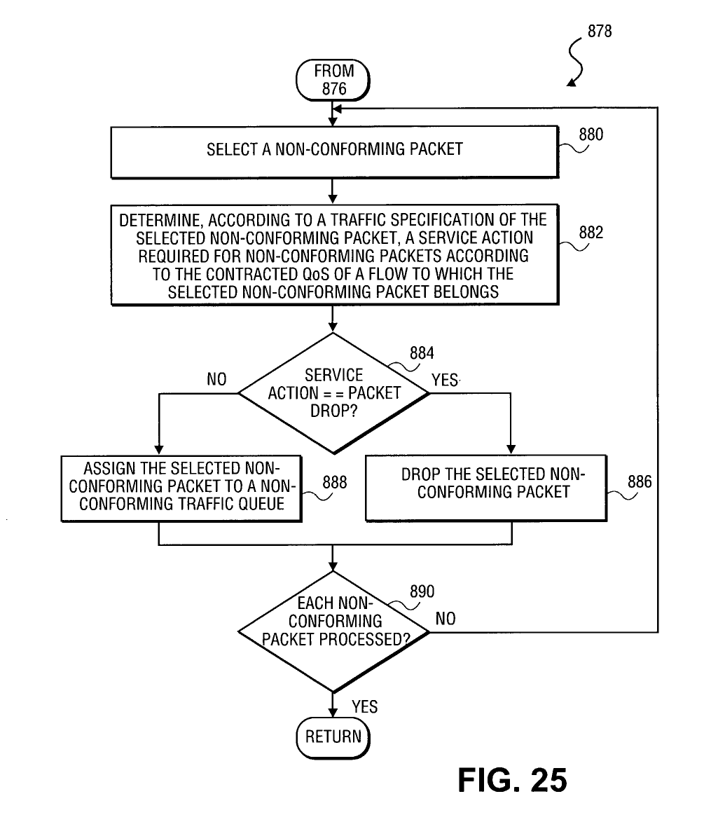

Referring now to FIG. 25, FIG. 25 depicts a flowchart illustrating an additional method 878 for assigning non-conforming packets to NCT queue 540 of process block 876, as depicted with reference to FIG. 18 and in accordance with the further embodiment of the present invention. Accordingly, at process block 880, a non-conforming packet is selected. Once selected, at process block 882, it is determined, according to the flow characteristics requested at flow set-up time, the service action required for non-conforming packets according to the flow to which the selected non-conforming packet belongs.

Consequently, when the determined service action requires dropping of non-conforming packets, at process block 884, process block 886 is performed. At process block 886, the non-conforming packet is assigned to absolute dropper 520 (FIG. 6), wherein the packet is dropped. Otherwise, at process block 888, the selected non-conforming packet is assigned to a non-conforming traffic queue 540. Finally, at process block 890, process blocks 880-888 are repeated for each identified non-conforming packet.

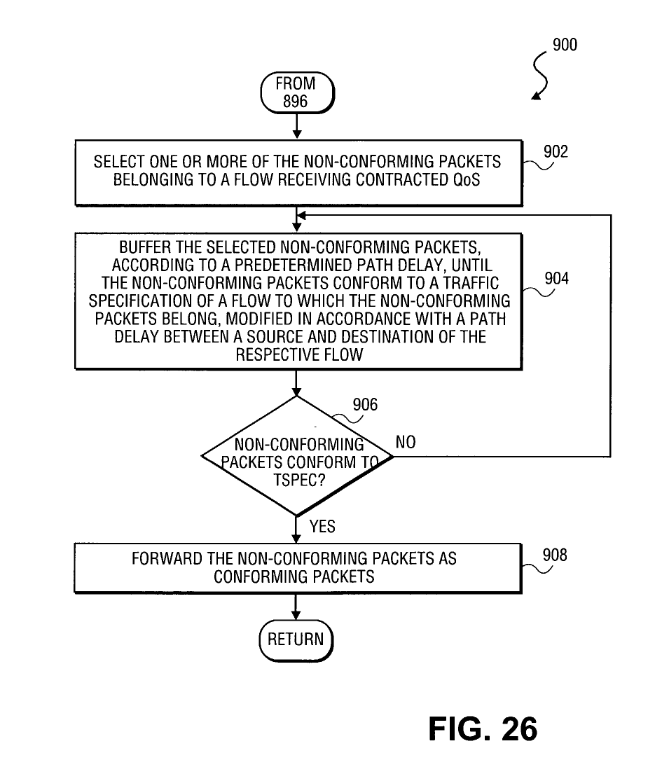

Finally, FIG. 26 illustrates an additional method 900 for servicing of packets at process block 896, as depicted with reference to FIG. 18 in accordance with the further embodiment of the present invention. At process block 902, one or more identified non-conforming packets belonging to a QoS flow are selected. Once selected, the non-conforming packets are buffered according to a predetermined path delay until the non-conforming packets conform to a traffic specification of a flow to which the non-conforming traffic's packets belong.

In one embodiment, the values defined by the TSpec may be modified in accordance with the path delay between a source and destination of the respective flow. Accordingly, at process block 906, it is determined whether the packets now conform to the modified values determined from the flow's TSpec. As such, process block 904 is repeated until the selected non-conforming packets now conform to the modified TSpec values. When such is the case, process block 908 is performed. At process block 908, the buffered non-conforming packets are forwarded as conforming packets.

Accordingly, utilizing the various embodiments of the present invention, INTSERV model services, such as controlled load service and guaranteed service may be provided within network elements utilizing DIFFSERV model building blocks. In doing so, a TCB may be generated within a network element, which may service INTSERV traffic, DIFFSERV traffic, as well as best effort traffic, without requiring separate modules in the network elements for processing of such traffic.

In other words, embodiments of the present invention eliminate the need for implementing separate data plane modules for providing controlled load service support in conjunction with guaranteed service support. In addition, the present invention leverages the benefits of statistical multiplexing providing by DIFFSERV modules in order to provide the strict guarantees defined by INTSERV services. As a result, the queueing delay experienced by packets is less than seen in traditional INTSERV implementations.

Alternate Embodiments

Several aspects of one implementation of the network element for providing TCB enabling varying QoS have been described. However, various implementations of the network element TCBs provide numerous features including, complementing, supplementing, and/or replacing the features described above. Features can be implemented as part of the network element or as part of the forwarding plane in different embodiment implementations. In addition, the foregoing description, for purposes of explanation, used specific nomenclature to provide a thorough understanding of the embodiments of the invention. However, it will be apparent to one skilled in the art that the specific details are not required in order to practice the embodiments of the invention.

In addition, although an embodiment described herein is directed to a network, it will be appreciated by those skilled in the art that the embodiments of the present invention can be applied to other systems. In fact, systems for hardware/software implementations of varying QoS fall within the embodiments of the present invention, as defined by the appended claims. The embodiments described above were chosen and described in order to best explain the principles of the embodiments of the invention and its practical applications. These embodiments were chosen to thereby enable others skilled in the art to best utilize the invention and various embodiments with various modifications as are suited to the particular use contemplated.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the embodiments of the present invention to the full extent indicated by the broad general meaning of the terms in which the appended claims are expressed.

The embodiments of the present invention provide many advantages over known techniques. In one embodiment, the present invention includes the ability of having an underlying DIFFSERV architecture, with its basic tenet of aggregation, to allow the use of shared resources via statistical multiplexing. In the TCB created within the network elements, packets from many flows are aggregated into a queue, which is serviced by the scheduler at a rate, which is the sum of the individual rates needed by the constituent flows. If some of the flows are not sending at their peak rates, better service can be provided (such as delays experienced by individual packets) to the remaining flows in that aggregate, since allocation was done for the worst case when all the flows are sending their maximum bursts at the same time.

In one embodiment, this approach can, in fact, be better than the traditional INTSERV method of reserving resources. In one embodiment, building blocks of a model that is designed to work on flow aggregates (DIFFSERV) with only qualitative service guarantees are used to provide flows with the service they would receive on a lightly loaded network, even if the network were actually heavily loaded. In other words, quantitative guarantees (an assured amount of bandwidth) are provided to individual flows by appropriately configuring QoS blocks that provide qualitative differentiation (DIFFSERV).

Having disclosed exemplary embodiments and the best mode, modifications and variations may be made to the disclosed embodiments while remaining within the scope of the embodiments of the invention as defined by the following claims.

What is claimed is:

1. A method comprising:
identifying, from an incoming traffic stream, packets belonging to one of a plurality of flows receiving a contracted quality of service (QoS);
determining, for each identified packet, whether the respective, identified packet conforms to a predetermined traffic specification for a respective flow to which the respective packet belongs;
assigning each conforming packet to a queue from one or more available according to a predetermined burst level of a respective flow to which the respective conforming packet belongs; and
selecting packets from each queue for transmission in order to maintain conformance of each selected packet to the predetermined packet traffic specification for a respective flow to which the respective, selected packet belongs.

2. The method of claim 1, wherein prior to identifying, the method further comprises:
determining a plurality of flows to receive a contracted QoS;
determining a respective identification code assigned to each packet belonging to a respective one of the plurality of determined flows; and
storing each of the determined identification codes to enable packet identification.

3. The method of claim 1, wherein identifying further comprising:
selecting a packet from the incoming packet stream;
when meta-data of the selected packet includes one or more identification codes corresponding to a flow receiving contracted QoS, providing the selected packet to a meter configured according to a token bucket traffic specification of the corresponding flow;
otherwise, providing the selected packet to a non-conforming traffic (NCT) queue; and
repeating the packet selecting, providing to a meter and providing to the NCT queue for each incoming packet.

4. The method of claim 1, wherein prior to identifying packets, the method further comprises:
selecting a flow from the plurality of flows receiving the contracted QoS;
generating, for the selected flow, a meter to detect whether received packets conform to a token bucket traffic specification of the selected flow; and
repeating the selecting and generating for each of the plurality of flows receiving contracted QoS.

5. The method of claim 1, wherein determining further comprises:
selecting a packet identified as belonging to a respective flow receiving contracted QoS;
calculating one or more traffic characteristics of the selected packet;
when the one or more calculated traffic characteristics conform to a traffic specification of the respective flow, identifying the selected packet as a conforming packet;
repeating the selecting, calculating and identifying for each packet belonging to the respective flow; and
repeating the selecting, calculating and identifying and repeating generating for each of the plurality of flows receiving contracted QoS.

6. The method of claim 1, wherein assigning further comprises:
selecting a conforming packet;
selecting, according to a flow to which the selected packet belongs, a predetermined burst level corresponding to the selected packet;
selecting a queue from one or more available queues set according to a queue a burst level range containing the selected, predetermined burst level;
providing the selected packet to the selected queue; and
repeating the selecting, selecting, selecting and providing for each conforming packet.

7. The method of claim 1, wherein prior to identifying packets, the method further comprises:
determining a burst level of each flow receiving contracted QoS;
grouping the determined burst levels into one or more burst ranges; and
generating a queue for each of the one or more determined burst level ranges.

8. The method of claim 1, wherein prior to selecting, the method further comprises:
selecting a queue from the one or more available queues;
determining an aggregate minimum rate profile for the selected queue;
determining an aggregate maximum rate profile for the selected queue;
calculating a threshold rate for the queue using the minimum rate profile and the maximum rate profile;
repeating the selecting, determining and calculating for each of the one or more available queues.

9. The method of claim 1, wherein selecting further comprises:
servicing packets from each queue according to a respective predetermined service rate of the respective queue;
when a current queue level of a respective queue exceeds a predetermined threshold level for the respective queue, servicing the queue at a predetermined increased service rate until the current queue level drops below the predetermined threshold level to reduce packet delay resulting from burst traffic; and
repeating the servicing at the predetermined service rate and servicing at the predetermined increased service rate for each packet contained within the one or more available queues.

10. The method of claim 1, wherein the contacted QoS comprises controlled-load service.

11. A computer readable storage medium including program instructions that direct a computer to perform one or more operations when executed by a processor, the program instructions comprising:
identifying, from an incoming traffic stream, packets belonging to one of a plurality of flows receiving a contracted quality of service (QoS);
determining, for each identified packet, whether the respective, identified packet conforms to a predetermined traffic specification for a respective flow to which the respective packet belongs;
assigning each conforming packet to a queue from one or more available according to a predetermined burst level of a respective flow to which the respective conforming packet belongs; and
selecting packets from each queue for transmission in order to maintain conformance of each selected packet to the predetermined packet traffic specification for a respective flow to which the respective, selected packet belongs.

12. The computer readable storage medium of claim 11, wherein prior to identifying, the method further comprises:
determining a plurality of flows to receive a contracted QoS;
determining a respective identification code assigned to each packet belonging to a respective one of the plurality of determined flows; and
storing each of the determined identification codes to enable packet identification.

13. The computer readable storage medium of claim 11, wherein identifying further comprising:
selecting a packet from the incoming packet stream;
when meta-data of the selected packet includes one or more identification codes corresponding to a flow receiving contracted QoS, providing the selected packet to a meter configured according to a token bucket traffic specification of the corresponding flow;
otherwise, providing the selected packet to a non-conforming traffic (NCT) queue; and
repeating the packet selecting, providing to a meter and providing to the NCT queue for each incoming packet.

14. The computer readable storage medium of claim 11, wherein prior to identifying packets, the method further comprises:
selecting a flow from the plurality of flows receiving the contracted QoS;
generating, for the selected flow, a meter to detect whether received packets conform to a token bucket traffic specification of the selected flow; and
repeating the selecting and generating for each of the plurality of flows receiving contracted QoS.

15. The computer readable storage medium of claim 11, wherein determining further comprises:
selecting a packet identified as belonging to a respective flow receiving contracted QoS;
calculating one or more traffic characteristics of the selected packet;
when the one or more calculated traffic characteristics conform to a traffic specification of the respective flow, identifying the selected packet as a conforming packet;
repeating the selecting, calculating and identifying for each packet belonging to the respective flow; and
repeating the selecting, calculating and identifying and repeating generating for each of the plurality of flows receiving contracted QoS.

16. The computer readable storage medium of claim 11, wherein assigning further comprises:
selecting a conforming packet;
selecting, according to a flow to which the selected packet belongs, a predetermined burst level corresponding to the selected packet;
selecting a queue from one or more available queues set according to a queue a burst level range containing the selected, predetermined burst level;
providing the selected packet to the selected queue; and
repeating the selecting, selecting, selecting and providing for each conforming packet.

17. The computer readable storage medium of claim 11, wherein prior to identifying packets, the method further comprises:
determining a burst level of each flow receiving contracted QoS;
grouping the determined burst levels into one or more burst level ranges; and
generating a queue for each of the one or more determined burst level ranges.

18. The computer readable storage medium of clam 11, wherein assigning further comprises:
selecting a non-conforming packet;
assigning the selected packet to a non-conforming queue; and
repeating the selecting and assigning for each non-conforming packet.

19. The computer readable storage medium of claim 11, wherein prior to selecting, the method further comprises:
selecting a queue from the one or more available queues;
determining an aggregate minimum rate profile for the selected queue;
determining an aggregate maximum rate profile for the selected queue;
calculating a threshold rate for the queue using the minimum rate profile and the maximum rate profile;
repeating the selecting, determining and calculating for each of the one or more available queues;
transmitting packets received from the one or more queues according to a threshold level of each queue in view of the calculated threshold level of the respective queue.

20. The computer readable storage medium of claim 11, wherein selecting further comprises:
servicing packets from each queue according to a respective predetermined service rate of the respective queue;
when a current queue level of a respective queue exceeds a predetermined threshold level for the respective queue, servicing the queue at a predetermined increased service rate until the current queue level drops below a predetermined level to reduce packet delay resulting from burst traffic; and
repeating the servicing at the predetermined service rate and servicing at the predetermined increased service rate for each packet contained within the one or more available queues.

21. A method comprising:
identifying, from an incoming traffic stream, packets belonging to one of a plurality of flows receiving a contracted quality of service (QoS);
determining, for each identified packet, whether the respective, identified packet conforms to one of a predetermined traffic specification for a respective flow to which the respective packet belongs and a modified traffic specification according to a predetermined network path delay;
assigning each conforming packet to a conforming traffic queue; and
assigning non-conforming packets to one of a non-conforming traffic queue and an absolute dropper according to the predetermined traffic specification for a respective flow to which the respective packet belongs

22. The method of claim 1, wherein identifying further comprising:
selecting a packet from the incoming packet stream;
when the meta-data of the selected packet includes one or more identification codes corresponding to a flow receiving contracted QoS, providing the selected packet to one of a meter configured according to a traffic specification of the corresponding flow and a meter configured according to a traffic specification modified in view of a path delay between a current network element and a source of the selected flow;
otherwise, providing the selected packet to a non-conforming traffic (NCT) service queue.

23. The method of claim 21, wherein prior to identifying packets, the method further comprises:
selecting a flow from the plurality of flows receiving the contracted QoS;
determining a path delay between a current network element and a source of the selected flow;
modifying a traffic specification of the selected flow according to the determined path delay;
generating, for the selected flow, a meter within the current network element to detect whether received packets belonging to the selected flow conform to the modified traffic specification of the selected flow; and
repeating the selecting, determining and generating for each of the plurality of flows receiving contracted QoS.

24. The method of claim 21, wherein determining further comprises:
selecting a packet identified as belonging to a respective flow receiving contracted QoS;
calculating one or more traffic characteristics of the selected packet;
when the one or more calculated traffic characteristics conform to a traffic specification of the respective flow, modified according to a path delay, identifying the selected packet as a conforming packet;
repeating the selecting, calculating and identifying for each packet belonging to the respective flow; and
repeating the selecting, calculating, identifying and repeating for each of the plurality of flows receiving contracted QoS.

25. The method of claim 24, wherein identifying further comprises:
determining, according to the contracted QoS requested by a respective flow, whether packets belonging to the requested flow are strictly metered;
when packets belonging to the respective flow are strictly metered, comparing the one or more calculated traffic characteristics to a traffic specification of the respective flow;
otherwise, comparing the one or more calculated traffic characteristics to the modified traffic specification of the respective flow; and
when the one or more calculated traffic characteristics conform to one of the traffic specification and the modified traffic specification of the respective flow, identifying the selected packet as a conforming packet.

26. The method of claim 21, wherein prior to identifying packets, the method further comprises:
determining a maximum queue level of the selected flow;
when the maximum queue level of the selected flow exceeds a queue level of the queue, generating an additional queue to process packets belonging to the selected flow; and
repeating the selecting, determining and generating for each of the plurality of flows requesting contracted QoS.

27. The method of claim 21, wherein assigning non-conforming packets further comprises:
selecting a non-conforming packet;
determining, according to a traffic specification of the selected non-conforming packet, service action required for non-conforming packets according to the contracted QoS of a flow to which the selected non-conforming packet belongs;
when the determined service action requires dropping of non-conforming packets, dropping the selected non-conforming packet;
otherwise, assigning the selected non-conforming packet to a non-conforming traffic queue; and
repeating the selecting, determining, dropping and assigning for each nonconforming packet.

28. The method of claim 21, wherein the contacted QoS comprises guaranteed service.

29. The method of claim 21, further comprising:
servicing packets from one of a conforming traffic queue, a non-conforming traffic queue and a best effort queue, according to a predetermined reservation rate.

30. The method of claim 29, wherein prior to identifying packets, the method further comprises:
selecting a flow receiving contracted QoS;
determining an aggregate network path delay between a source and a destination network path of the selected flow;
determining the reservation rate according to a traffic specification of the flow, in view of the determined aggregate delay, to achieve a desired delay bound in accordance with the contracted QoS received by the selected flow;
transmitting the reservation rate to a source of the selected flow; and
repeating the selecting, determining, determining and transmitting for each for receiving contracted QoS.

31. The method of claim 29, wherein servicing further comprises:
selecting one or more of the non-conforming packets belong to a flow receiving contracted QoS;
buffering the selected non-conforming packets according to a predetermined path delay until the non-conforming packets conform to a traffic specification of a flow to which the non-conforming packets belong; and
once the buffering of the selected non-conforming packets is complete, forwarding the non-conforming packets as conforming packets.

32. An apparatus, comprising:
an input classifier to route incoming packets belonging to one of a plurality of flows receiving contacted quality of service (QoS);
a plurality of meters, each respective meter to receive packets routed from the input classifier belonging to a flow assigned to the respective meter and determine whether the received packets conform to a traffic specification of the respective flow assigned to the respective meter;
one or more queues to receive conforming packets from the plurality of meters; and
a scheduler to service packets from the one or more queues.

33. The apparatus of claim 32, wherein the plurality of meters are configured according to one of a respective traffic specification of a respective flow assigned to the respective meter and a traffic specification of the respective flow modified in view of a network path delay between a source and destinations of the respective flow.

34. The apparatus of claim 32, wherein the queues further comprise:
a low burst level queue to receive packets belong to flows having a low burst level;
a medium burst level queue to receive packets belong to flows having a low burst level; and
a high burst level queue to receive packets belong to flows having a low burst level.

35. The apparatus of claim 32, wherein the queues further comprise:
a conforming traffic queue to receive packets determined to conform to their respective traffics specification according to a respective meter;
a non-conforming traffic queue to receive a portion of non-conforming traffic;
an absolute dropper to drop a remaining portion of the non-conforming packets; and
a best effort queue to receive any remaining packets.

36. The apparatus of claim 32, further comprising:
a rate adaptive shaper to maintain conformance of each selected packet to the predetermined packet traffic specification for a respective flow to which the respective, selected packet belongs.

37. The apparatus of claim 32, wherein the contracted QoS comprises one of controlled-load service and guaranteed service.

38. A system comprising:
a plurality of network elements linked together to form an end-to-end datapath between a source network element and a destination network element, wherein each network element includes a traffic conditioning block comprised of differentiated services (DIFFSERV), datapath elements linked together to enable one of guaranteed service and controlled-load service to a flow of packets transmitted between the source network element and the destination network element.

39. The system of claim 38, wherein each network element comprises:
an input classifier to route incoming packets belonging to one of a plurality of flows receiving contacted quality of service (QoS);
a plurality of meters, each respective meter to receive packets routed from the input classifier belonging to a flow assigned to the respective meter and determine whether the received packets conform to a traffic specification of the respective flow assigned to the respective meter;
one or more queues to receive conforming packets from the plurality of meters; and
a scheduler to service packets from the one or more queues.

40. The system of claim 39, wherein the plurality of meters are configured according to one of a respective traffic specification of a respective flow assigned to the respective meter and a traffic specification of the respective flow modified in view of a network path delay between a source and destinations of the respective flow.

41. The system of claim 39, wherein the queues further comprise:
a low burst level queue to receive packets belong to flows having a low burst level;
a medium burst level queue to receive packets belong to flows having a low burst level; and
a high burst level queue to receive packets belong to flows having a low burst level.

42. The system of claim 38, wherein the network elements further comprise:
a conforming traffic queue to receive packets determined to conform to their respective traffics specification according to a respective meter;
a non-conforming traffic queue to receive a portion of non-conforming traffic;
an absolute dropper to drop a remaining portion of the non-conforming packets; and
a best effort queue to receive any remaining packets.

43. The system of claim 38, wherein the network elements further comprise:
a rate adaptive shaper to maintain conformance of each selected packet to the predetermined packet traffic specification for a respective flow to which the respective, selected packet belongs.
